(19) United States
(12) Patent Application Publication
(10) Pub. No.: US 2025/0269955 A1
(43) Pub. Date: Aug. 28, 2025

(54) ELECTRIC VERTICAL TAKE-OFF AND LANDING (EVTOL) AIRCRAFT SYSTEMS AND METHODS FOR REDUCING MOTION SICKNESS

(71) Applicant: Feng MA, Cary, NC (US)

(72) Inventor: Feng MA, Cary, NC (US)

(21) Appl. No.: 19/031,987

(22) Filed: Jan. 18, 2025

Related U.S. Application Data
(60) Provisional application No. 63/557,595, filed on Feb. 25, 2024.

(51) Int. Cl. B64C 29/00; A41D 1/00; B64C 3/24; B64C 3/30; B64D 11/06; B64D 17/62; B64D 27/31; B64D 27/34; B64D 45/00; B64D 47/00; F03D 9/00; F03D 9/32; G09B 9/08

(52) U.S. Cl. CPC B64C 29/0091; B64C 3/24; B64C 3/30; B64C 29/0008; B64D 11/06; B64D 17/62; B64D 27/31; B64D 27/34; B64D 45/00; B64D 47/00; F03D 9/007; F03D 9/322; G09B 9/08; A41D 1/002; B64D 2221/00; F05B 2220/708; F05B 2240/923

(57) ABSTRACT

An electric vertical take-off and landing (eVTOL) aircraft can enhance energy efficiency, safety, and operational range. A deployable wing structure can provide aerodynamic lift during horizontal flight, reducing reliance on energy-intensive propellers. Integrated flexible solar panels capture solar energy, contributing additional power and optimizing energy management. The wing system also includes an emergency descent mode, doubling as a glide-assist device for controlled landings during critical failures. The system offers modular configurations for various missions, ensuring adaptability and improved flight performance. The eVTOL can be implemented with systems and methods for mitigating motion sickness. The systems integrate tactile feedback systems into wearable devices and environmental components. Sensors detect motion and environmental changes, and a computing device can generate corresponding tactile feedback signals. Tactile actuators embedded in the devices or components provide non-visual motion cues, such as pressure, vibration, and haptic feedback, to resolve sensory mismatches between the vestibular and proprioceptive systems.

### CROSS-REFERENCE TO RELATED APPLICATIONS

The present disclosure claims priority to U.S. Provisional Patent Application No. 63/557,595 filed Feb. 25, 2024, the disclosure of which is hereby incorporated by reference in its entirety.

### BACKGROUND

The field of urban and regional air mobility has undergone significant advancements with the advent of electric vertical take-off and landing (eVTOL) aircraft. These aircraft are heralded as a transformative solution to address increasing demands for efficient, sustainable, and rapid transport within urban environments. They offer the potential to reduce traffic congestion, lower emissions, and provide faster travel times. As technology continues to evolve, eVTOLs are expected to integrate seamlessly into existing transportation networks, enhancing connectivity and accessibility. Motion sickness is a common condition caused by a sensory mismatch between the brain's perception of movement from the vestibular system and other sensory inputs, such as proprioception.

### SUMMARY

The present disclosure is related to a multifunctional auxiliary wing system for electric vertical take-off and landing (eVTOL) aircraft, and systems and methods for reducing motion sickness using tactile feedback and interactive participation.

Various embodiments of the present disclosure provide a novel and transformative auxiliary wing system for electric vertical take-off and landing (eVTOL) aircraft, introducing advancements in energy efficiency, operational versatility, and safety. Designed to address the inherent limitations of conventional eVTOL designs, this system enhances the capabilities of eVTOL aircraft, offering solutions that are tailored to urban and regional air transportation challenges. By incorporating advanced materials, renewable energy technologies, and intelligent aerodynamic features, this disclosure delivers significant improvements to flight efficiency, range, safety, and adaptability.

The auxiliary wing system can include a deployable structure that transitions seamlessly between vertical takeoff and horizontal flight modes. During takeoff and landing, the wings remain compactly stored against the fuselage to avoid interference with vertical propulsion systems and minimize drag. Once the aircraft reaches a suitable altitude, the wing system deploys to provide aerodynamic lift, significantly reducing reliance on energy-intensive rotors. This transition enhances energy efficiency, allowing the aircraft to glide using uplifting airflow and reducing power consumption during horizontal flight.

The wing deployment mechanism incorporates advanced automated actuators or manual controls to ensure a precise, smooth transition between flight phases. These mechanisms are designed for reliability and durability, adapting to various flight conditions. The integration of control systems with real-time monitoring ensures that the wings maintain optimal performance, regardless of external factors such as wind speed or altitude changes.

A defining feature of this disclosure is its multi-layered energy generation and management system, which combines several renewable energy technologies. Flexible solar panels integrated into the auxiliary wings capture solar energy during flight, converting it into electrical power for propulsion systems, avionics, and battery storage. These lightweight panels are aerodynamically efficient and dynamically managed by an onboard energy system that optimizes power distribution based on real-time sunlight conditions.

Supplemental energy harvesting technologies, such as piezoelectric materials and small wind turbines, contribute additional power by capturing kinetic energy from airflow and wing vibrations. Piezoelectric materials embedded within the wings convert mechanical stress into electrical energy, while strategically placed wind turbines harness airflow to generate supplemental power. Advanced sensors and control systems dynamically adjust these energy-harvesting devices to maintain peak efficiency, adapting to varying flight conditions and ensuring minimal impact on aerodynamic performance.

This comprehensive energy generation system not only reduces reliance on traditional battery storage but also extends the operational range of the eVTOL aircraft. By incorporating renewable energy sources, the disclosure aligns with global sustainability goals, reducing carbon emissions and promoting cleaner energy solutions for urban air mobility.

The auxiliary wing system is designed to improve aerodynamic efficiency and flight performance. The wings are shaped to maximize lift-to-drag ratios during horizontal flight, enabling the aircraft to achieve optimal glide efficiency. Adjustable wing geometries and integrated control surfaces, such as flaps and ailerons, provide precise control over flight dynamics, enhancing stability and maneuverability across various flight scenarios. These features ensure that the aircraft performs efficiently in both urban and regional environments, where conditions may vary significantly.

Constructed from high-strength, lightweight materials, such as carbon fiber composites and advanced polymers, the wings maintain durability while minimizing overall aircraft weight. Smart materials embedded within the wing structure allow for real-time monitoring and adaptive responses to environmental conditions, further enhancing performance and safety. The integration of these advanced materials ensures that the auxiliary wing system meets the demands of modern aviation while maintaining structural integrity and longevity.

Safety can be significantly improved using various embodiments of the present disclosure, and the auxiliary wing system includes an emergency descent mode to address critical flight failures. In situations where electrical power is low or immediate landing is unfeasible, the wings can transition into a glide-assist or parachute configuration. This feature reduces descent rates, enabling controlled landings and minimizing potential risks to passengers, cargo, and the aircraft itself.

The emergency descent capability can be triggered automatically by onboard systems detecting critical failures or can be initiated manually by the pilot. The wing system can deploy rapidly, potentially through a ballistic rocket launch mechanism to deploy the parachute quickly, which can stabilize the aircraft and provide time for the crew to address the situation. This functionality can enhance passenger confidence and operational reliability, helping to ensure safety across a range of unexpected scenarios.

The modular design of the auxiliary wing system allows for extensive customization based on mission requirements. Wing configurations can be tailored to specific applications, such as passenger transport, cargo delivery, or emergency response. This flexibility ensures that the eVTOL aircraft can adapt to diverse operational scenarios, enhancing its utility across multiple industries.

In addition to supporting new eVTOL models, the system is retrofittable onto existing aircraft, broadening its market applicability. Modular sections of the wings can be easily replaced or reconfigured, enabling quick maintenance and adaptation to changing mission needs. This adaptability makes the auxiliary wing system a versatile solution for operators in urban air mobility, regional transport, and beyond.

The disclosure incorporates advanced renewable energy systems to enhance sustainability and reduce environmental impact. Flexible solar panels, piezoelectric materials, and wind turbines work in synergy to generate supplemental electricity, reducing the aircraft's reliance on traditional power sources. These technologies are integrated seamlessly into the wing and fuselage structures, ensuring that they do not compromise the aircraft's aerodynamic profile or performance.

The energy management system dynamically regulates power distribution, prioritizing critical systems such as propulsion and avionics while storing excess energy in high-efficiency batteries. This approach ensures consistent power availability throughout the flight and optimizes energy usage to meet operational demands.

Various embodiments of the present disclosure can help transform the aviation industry by offering a versatile and energy-efficient solution for eVTOL aircraft. Its potential applications include:

Urban Air Mobility: Providing safe, efficient passenger transport within and between cities, reducing traffic congestion and travel times.

Cargo Logistics: Supporting extended-range package and freight delivery, enabling cost-effective logistics solutions.

Emergency Services: Facilitating rapid deployment for medical evacuations, disaster response, and firefighting missions.

Agriculture and Environmental Monitoring: Enabling aerial data collection for precision agriculture and environmental research.

Military and Defense: Supporting reconnaissance, surveillance, and tactical operations with enhanced safety features.

The integration of renewable energy systems, advanced materials, and safety mechanisms positions this auxiliary wing system as a groundbreaking innovation in sustainable aviation technology. Its ability to reduce energy consumption, enhance safety, and adapt to diverse operational needs addresses the growing demand for efficient and reliable eVTOL solutions.

The multifunctional auxiliary wing system represents a significant advancement in eVTOL technology, addressing challenges in energy efficiency, flight performance, and safety. By integrating renewable energy technologies, advanced aerodynamic features, and modular designs, the disclosure sets a new standard for sustainable and adaptable eVTOL aircraft. Its transformative approach not only enhances operational capabilities but also aligns with global efforts to reduce carbon emissions and promote clean energy solutions. This disclosure lays the foundation for future innovations in urban air mobility, regional transport, and sustainable aviation, fostering broader adoption of eVTOL technology across multiple sectors.

The present disclosure also relates to a system and method for mitigating motion sickness using tactile feedback rather than visual cues, which can be used by passengers of the eVTOL aircraft, or any other vehicles. Motion sickness arises from sensory conflicts between the vestibular system and proprioceptive inputs, particularly when visual references are unavailable. This disclosure addresses motion-induced discomfort by integrating wearable haptic feedback devices and environmental components that provide real-time tactile cues to align sensory perception with actual movement.

The system includes tactile feedback mechanisms embedded in helmets, headbands, vests, and vehicle seats. These components are equipped with haptic actuators that deliver pressure, vibrations, and other haptic signals corresponding to detected motion. The system employs motion sensors such as gyroscopes, GPS, cameras, radar, and LIDAR to gather real-time movement data. A computing device processes the sensor data, generating tactile feedback signals to assist users in anticipating and adapting to motion changes.

Additionally, the disclosure integrates artificial intelligence (AI) algorithms that predict vehicle movements, pre-plan motion guidance, and generate early alerts to reduce sensory mismatches. By proactively adjusting haptic feedback based on anticipated movements, the system enhances its effectiveness in mitigating motion sickness.

The disclosure further introduces an interactive device designed to engage users in active participation to reduce motion sickness. Inspired by the observation that drivers and pilots rarely experience motion sickness, the device allows users to simulate driving or piloting actions, thereby engaging their brains in motion anticipation. This device includes a handheld or mounted control unit, haptic actuators, and a visual simulation interface to align the user's actions with the predicted motion of a vehicle or aircraft. The system can be integrated into steering wheels, game controllers, tablets, or smartphones, offering a customizable motion simulation experience.

Applications of this disclosure include transportation, virtual reality (VR) and gaming, and healthcare rehabilitation. The system can be integrated into cars, airplanes, boats, and other vehicles to enhance passenger comfort, particularly for visually impaired individuals or passengers in autonomous vehicles. In VR environments, the system reduces motion sickness during immersive experiences.

In healthcare settings, it aids patients with balance disorders or vestibular dysfunctions by improving sensory integration.

By leveraging tactile feedback and AI-driven predictive modeling, this disclosure provides a non-visual solution to motion sickness, making it accessible, adaptable, and effective across various environments. The integration of real-time sensor feedback, predictive motion analysis, and interactive engagement ensures a versatile and scalable approach to improving user comfort in motion-sensitive situations.

In some embodiments, an auxiliary wing system for an electric vertical take-off and landing (eVTOL) aircraft is provided, including: a deployable wing structure compactly stored during vertical takeoff and landing; an energy generation system integrated into the deployable wing structure, wherein the energy generation system includes: flexible solar panels for capturing solar energy, and piezoelectric materials for generating electricity from wing vibrations; a wing deployment mechanism comprising automated actuators or manual controls for transitioning the deployable wing between stored and extended configurations; and a modular design enabling the auxiliary wing system to be retrofitted onto existing eVTOL models or customized for specific mission requirements.

In some embodiments, the auxiliary wing system further includes an onboard microcontroller configured to dynamically regulate energy distribution among the aircraft's systems based on varying flight conditions.

In some embodiments, the deployable wing structure comprises multiple stacked sub-wings that unfold sequentially to form an expanded aerodynamic surface.

In some embodiments, wherein the modular design includes detachable sections of the deployable wing structure, enabling easy maintenance and reconfiguration based on operational needs.

In some embodiments, the piezoelectric materials are embedded along a trailing edge of the deployable wing to maximize energy generation from aerodynamic vibrations.

In some embodiments, the modular design is configured to facilitate the integration of auxiliary communication systems, including antenna arrays, for enhanced data transmission.

In some embodiments, the method further includes: predicting future motion changes using an artificial intelligence model trained on vehicle dynamics and user response data; preemptively adjusting tactile feedback signals before actual motion changes occur; and customizing feedback settings based on user preferences and sensitivity levels.

Some embodiments of the present disclosure provide an interactive apparatus for reducing motion sickness, including: An audio, visual or haptic feedback device to facilitate active participation in simulated vehicle control; one or more sensors configured to detect movement, orientation, and acceleration of the vehicle and/or control inputs from an operator of the vehicle; A visual simulation interface configured to display predicted vehicle movement and guide a user/passenger in synchronizing their actions with motion changes; and a feedback mechanism configured to adjust vibratory, rotational, or pressure-based cues based on user input and vehicle motion data.

In some embodiments, the device is integrated with a vehicle simulation system and provides real-time haptic cues corresponding to vehicle movements.

In some embodiments, the user actively engages in simulated driving movements to align sensory inputs with anticipated motion, reducing motion sickness symptoms.

In some embodiments, the device incorporates artificial intelligence-driven feedback adjustment to optimize haptic cues based on past usage data and individual user responses.

In some embodiments, the visual simulation interface comprises at least one of: a game controller or steering wheel equipped with a display screen showing simulated vehicle movement; a tablet or smartphone displaying anticipated vehicle acceleration, deceleration, and directional changes.

In some embodiments, the interactive device further includes a gamification system configured to provide rewards or feedback based on user engagement and accuracy in following simulated motion cues.

In some embodiments, a system for integrating haptic feedback into transportation and virtual environments is provided, including: a modular haptic actuator system configured to be embedded into at least one of wearable devices, vehicle interiors, or virtual reality accessories; a real-time motion tracking system utilizing gyroscopes, GPS, and artificial intelligence-driven predictions to dynamically adjust haptic feedback; and a wireless connectivity module configured to enable synchronization between vehicle motion data and haptic feedback devices.

An artificial intelligence module analyzes motion patterns, predicts vehicle movements, and generates preemptive tactile feedback cues to further enhance motion sickness mitigation. Interactive devices are also disclosed, combining tactile feedback with visual simulations to provide an engaging and effective means of reducing motion sickness symptoms.

### BRIEF DESCRIPTION OF THE DRAWINGS

To elucidate the technical solutions presented in the embodiments of the present application, a brief introduction to the accompanying drawings is provided. The drawings included in the following description represent certain embodiments of the present application.

FIG. 1 is a perspective view of an eVTOL aircraft with the multifunctional auxiliary wing system in its deployed state. The auxiliary wing system is a parachute-style glider according to one embodiment.

FIG. 2 illustrate the front view of the eVTOL aircraft with the multifunctional auxiliary wing system in its deployed state according to one embodiment.

FIG. 3 is a perspective view of the eVTOL aircraft with a foldable glider wing system in its deployed state. The glider wing is supported by fixed columns according to one embodiment.

FIG. 4 is a perspective view of the e VTOL aircraft with the retractable auxiliary wing installed in the landing gear of the aircraft, and is in its expanded state, according to another embodiment.

FIG. 5 illustrates the front, top, and cross-sectional view of the auxiliary glider wing in its expanded state, according to one embodiment.

FIG. 6 illustrates the front, and top view of the foldable hang glider of the aircraft in its expanded state, according to another embodiment.

FIG. 7 illustrates the foldable hang glider in the closed position, installed on top of the eVTOL aircraft through two columns, according to another embodiment.

FIG. 8 illustrates the steps involved in deploying the auxiliary parachute wing, starting from the initial state, through the deployment process led by the pilot parachute, to its final stable position, according to another embodiment.

FIG. 9 illustrates the steps involved in deploying the auxiliary parachute wing, starting from the initial state, through the deployment process led by the pilot parachute or a Ballistic Recovery Systems (BRS) during emergency situation, to its final stable position, according to another embodiment.

FIG. 10 illustrates the process of the flow chart of the parachute wing deployment of an aircraft.

FIG. 11 illustrates the Tactile Feedback System Integrated into a Wearable Device, Such as a Helmet or Headband.

FIG. 12 illustrates the Haptic or Force Feedback System integrated into a helmet or headband, demonstrating the actuators used for application of pressure to simulate motion.

FIG. 13 illustrates a haptic or force feedback system in action, through actuators integrated into a wearable headband to generate pressures in orders

FIG. 14 illustrates a piezoelectric haptic actuator structural, showing the metal plate and applying positive or negative electrical charges will bend the actuator in reversed direction, which can generate the pressure.

FIG. 15 illustrate a helmet that generates pressure to assist users in anticipating vehicle movements in various directions.

FIG. 16 illustrates an ergonomically designed seat with integrated haptic actuators providing tactile feedback through pressure to predict turns, accelerations, or decelerations.

FIG. 17 illustrates a vest integrated with pressure-generating actuators that provide tactile feedback to the human body, allowing users to anticipate vehicle movements.

FIG. 18 illustrates a side view schematic diagram of a system to prevent motion sickness in vehicles, according to some examples of the present disclosure.

FIG. 19 illustrates a side view schematic diagram of a system to prevent motion sickness in aircraft, according some examples of the present disclosure.

FIG. 20 illustrates a game controller and a steering wheel, both integrated with embedded screens tablet or smartphone, displaying a simulated driving or flight interface.

FIG. 21 illustrates a user seated in an airplane, holding an aircraft driving simulation unit to simulate the experience of controlling the aircraft.

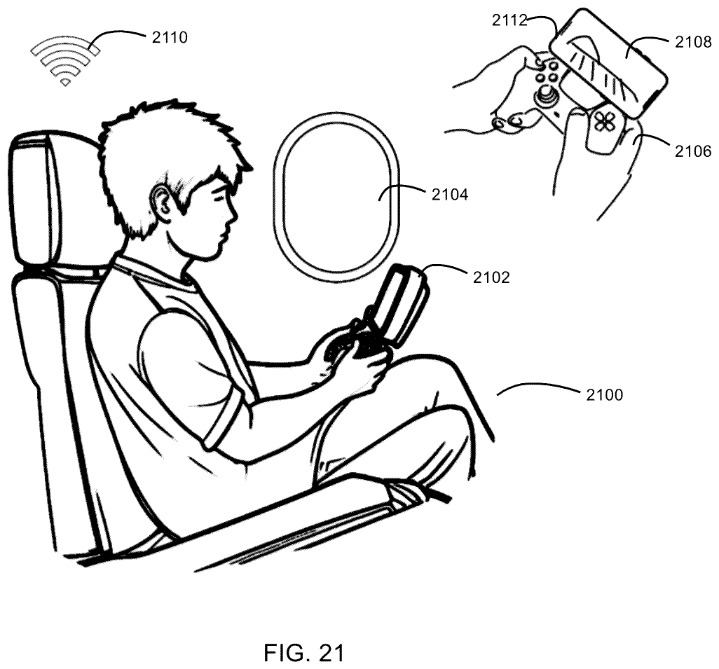

FIG. 22 illustrates a Haptic Feedback System represented as a structured block diagram. It visually depicts how different components and subsystems are interconnected to enable haptic feedback for various applications. The system integrates AI, sensors, data processing, and wearable or environmental components to provide enhanced feedback mechanisms.

The accompanying drawings serve to depict the principles and operations of the embodiments, offering a visual representation to support understanding. The figures are not to be construed as limiting the scope of the application; rather, they are provided as examples to aid in comprehension. It is intended that all modifications, equivalents, and alternatives that fall within the spirit and scope of the present application, as defined by the appended claims, are encompassed.

### DETAILED DESCRIPTION

Traditional solutions include medications like antihistamines, acupressure wristbands, and behavioral strategies such as focusing on the horizon or controlling breathing. Additionally, some people find relief through ginger supplements or by ensuring adequate ventilation and fresh air.

In the field of motion sickness mitigation, existing technical based solutions predominantly focus on providing visual references to passengers in vehicles, as seen in systems that project images or display visual references aligned with vehicle movements. These systems, however, are not suitable for individuals who lack visual input or are unable to benefit from visual cues due to visual impairments. Other methods involve adjusting vehicle components or environmental settings based on sensor data to alleviate symptoms, yet these approaches do not address the underlying sensory conflict between vestibular and proprioceptive inputs.

While virtual reality systems synchronize visual content with physical motion, they fall short in situations where visual input is unavailable or ineffective. Solutions that rely on visual cues are unsuitable for individuals with visual impairments or those who find visual stimuli uncomfortable. Additionally, traditional visual cue-based solutions often exclude passenger participation and neglect the importance of engaging other sensory modalities. Consequently, creating a non-visual approach that addresses the root sensory conflicts, such as through auditory or tactile feedback, could provide a more inclusive and effective way to alleviate motion sickness.

Traditional eVTOL aircraft rely heavily on rotors or propellers for both vertical lift during takeoff and horizontal propulsion during sustained flight. While this dual reliance enables vertical and horizontal flight capabilities, it presents several inherent limitations, particularly in energy consumption, operational range, and safety. The reliance on energy-intensive rotors or propellers during horizontal flight significantly limits the operational efficiency of eVTOL aircraft. Sustained horizontal propulsion requires high levels of power, depleting onboard energy reserves at a rapid rate and reducing the aircraft's range. This limitation is particularly problematic for missions that require extended flight durations, such as regional passenger transport, cargo delivery, or emergency response operations. Additionally, the absence of renewable energy integration in conventional e VTOL designs further exacerbates energy inefficiency and contributes to higher operational costs.

Another challenge associated with traditional eVTOL designs is the lack of an integrated safety mechanism for controlled descent during emergencies. In the event of critical system failures, such as power loss or propulsion malfunction, the reliance on energy-intensive systems for descent can lead to uncontrolled scenarios, endangering passengers, cargo, and the aircraft itself. Current designs offer limited or no redundancy in the form of deployable safety mechanisms, leaving operators with few options to ensure controlled landings during emergencies.

Operational versatility is also constrained in existing eVTOL systems due to their rigid structural configurations. Fixed-wing designs or permanently attached auxiliary components may interfere with vertical propulsion systems during takeoff and landing phases, limiting the adaptability of the aircraft for diverse mission requirements. Furthermore, traditional designs often fail to incorporate modular or customizable elements that would allow operators to optimize the aircraft's performance for specific operational scenarios, such as varying payload capacities, flight distances, or environmental conditions.

The absence of renewable energy integration in traditional eVTOL aircraft represents a missed opportunity to harness sustainable energy sources during flight. The integration of solar panels, piezoelectric materials, or wind turbines into the design of e VTOL systems could address this gap by supplementing onboard power reserves, reducing energy consumption, and lowering the aircraft's overall carbon footprint. However, the lack of innovation in this area has resulted in continued dependence on conventional power systems, which are less efficient and less environmentally friendly.

To address these, the present disclosure introduces a multifunctional auxiliary wing system that enhances the energy efficiency, safety, and versatility of eVTOL aircraft. The auxiliary wing system includes a deployable wing structure that provides aerodynamic lift during horizontal flight, thereby reducing reliance on rotors and significantly lowering energy consumption. The system integrates renewable energy technologies, such as flexible solar panels, piezoelectric materials, and wind turbines, to capture and utilize sustainable energy during flight. Additionally, the auxiliary wing system features an emergency descent functionality, enabling controlled landings during critical system failures.

Various embodiments of the present disclosure can have by its modular and customizable design, allowing the auxiliary wing system to be tailored to specific mission requirements. This adaptability enables the aircraft to perform efficiently across a wide range of applications, including passenger transport, cargo delivery, environmental monitoring, and emergency services. The modular design also facilitates retrofitting the auxiliary wing system onto existing eVTOL models, broadening its applicability and utility.

As such, various embodiments of the present disclosure can address critical limitations in traditional eVTOL aircraft by introducing an energy-efficient, safe, and versatile auxiliary wing system. By integrating renewable energy technologies, emergency descent functionality, and a modular design, the disclosure represents a transformative advancement in e VTOL technology, paving the way for sustainable and reliable urban and regional air mobility. In accordance with the present application, illustrative embodiments of the system and method of use are described herein. It should be understood that in the development of any specific embodiment, numerous implementation-specific decisions must be made to achieve the developer's particular objectives, such as adhering to system-related and business-related constraints, which may differ across various implementations. As such, the embodiments described are not intended to limit the scope of the disclosure but rather to provide examples of how the disclosure can be implemented.

These examples are provided to illustrate potential applications and should not be construed as exhaustive or limiting. Variations and modifications may be made without departing from the spirit and scope of the disclosure. Therefore, the disclosure should be considered as broadly applicable, with the potential for adaptation to suit different needs and requirements. The claims that follow is intended to define the scope of the disclosure, and any modifications or variations that fall within the boundaries of these claims are considered to be within the scope of the disclosure.

The system and method of use are comprehensible in terms of both structure and operation, as revealed by the accompanying drawings and the detailed description provided herein. Multiple embodiments of the system are disclosed, and it is to be understood that various components, parts, and features of these different embodiments may be combined and/or interchanged, all within the scope of the present application. Although not all variations and specific embodiments are depicted in the drawings, the mixing and matching of features, elements, and/or functions among various embodiments are expressly contemplated.

This disclosure enables one of ordinary skill in the art to appreciate that features, elements, and/or functions of one embodiment may be incorporated into another embodiment as deemed appropriate, unless otherwise specified. The preferred embodiment described herein is not intended to be exhaustive or to limit the disclosure to the precise form disclosed. Rather, it is selected and described to elucidate the principles of the disclosure and its application and practical use, thereby enabling others skilled in the art to follow its teachings. It should be understood that modifications and variations can be made without departing from the spirit and scope of the disclosure. The disclosure is intended to cover all such alternatives, modifications, and equivalents as may be included within the scope of the claims.

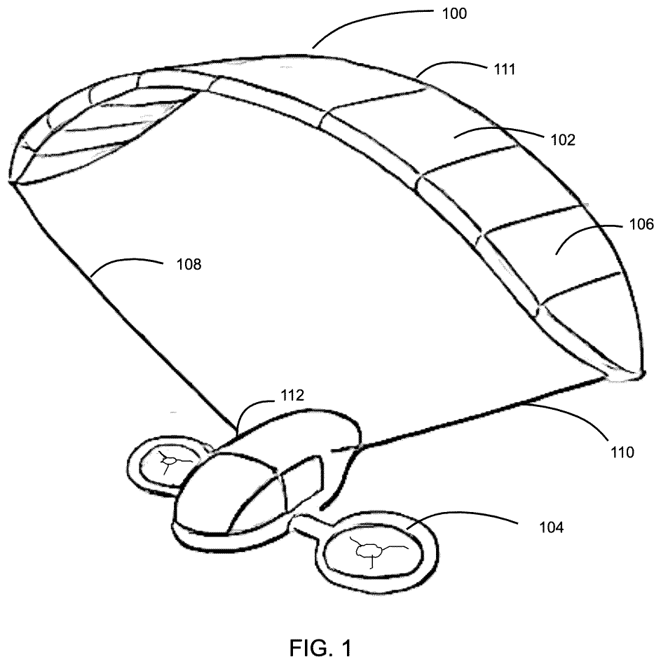

FIG. 1 provides a perspective view of an eVTOL aircraft system 100 in a flight configuration, illustrating the multifunctional auxiliary wing system in its deployed configuration. The embodiment illustrated in FIG. 1 shows an integration of the auxiliary wing or glider 102 with the aircraft's body, detailing its role in enhancing flight performance, energy management, and safety features. The auxiliary wing system can function as a parachute-style glider, which can be deployed after takeoff, representing one embodiment of the system. The vertical take-off propeller 104 can serve as a primary mechanism for facilitating vertical ascent. The thin-film solar cell 106 and the solar power charging cable 108 can be components configured for energy generation and management. The glider attaching cable and control cord 110 can provide secure attachment and control of the auxiliary wing, while the small eVTOL aircraft fuselage 112 constitutes the main body of the aircraft. Although embodiments of the system and method of use are described herein, it is understood that in the development of any specific embodiment, numerous implementation-specific decisions will be made to achieve particular objectives, such as compliance with system-related and business-related constraints, which will vary across different implementations.

The eVTOL aircraft system 100 illustrated in FIG. 1 is to improve the urban and regional air transportation by offering efficient, electric-powered vertical take-off and landing capabilities. The multifunctional auxiliary wing system, as depicted in FIG. 1, can address the traditional reliance on propellers or rotors for both vertical lift and horizontal flight, which can be energy-intensive. By introducing a deployable wing structure, the system can reduce energy consumption during sustained flight, thereby extending the operational range and enhancing safety and operational versatility.

The auxiliary wing or glider 102 can be a deployable structure stored during take-off and landing phases to avoid interference with vertical propulsion and to reduce the space needed for the parking, taking off, and landing of the aircraft. Once the aircraft reaches a suitable altitude, the wing can be deployed to provide aerodynamic lift, allowing the aircraft to glide using uplifting airflow. Fixed-wing aircraft are generally much more energy efficient than helicopters because the aerodynamic lift generated by a large/long wing can significantly reduce the drag while generating lift more efficiently compared with rotary wings.

The deployable/extendable/retractable wings not only can reduce energy (e.g., fuel) consumption significantly, but also can improve safety as the wings provide much better gliding properties of the aircraft in case of engine/propulsion system failures. This transition reduces the reliance on energy-intensive propellers for horizontal flight, thereby lowering energy consumption and extending the operational range. The deployment mechanism includes automated actuators or manual controls that release and extend the wing smoothly after vertical ascent, ensuring seamless integration with the aircraft's flight dynamics. The vertical take-off propeller 104 is for the initial ascent of the eVTOL aircraft. It provides the necessary thrust for vertical lift-off, allowing the aircraft to reach the altitude required for the auxiliary wing deployment. This design ensures that the aircraft can achieve vertical lift-off and descent without any hindrances or obstructions caused by the wings, maintaining optimal flight performance and safety.

The thin-film solar cell 106 and solar power charging cable 108 are integral to the energy management system of the eVTOL aircraft. The flexible solar panels integrated onto the surface of the retractable wing capture solar energy during flight, contributing additional power to the aircraft's systems. The onboard energy management system regulates the distribution of generated electricity to propulsion systems, avionics, and battery storage, dynamically adapting to varying sunlight conditions to optimize energy harvest and usage. This renewable energy source reduces the aircraft's carbon footprint and operating costs. The glider wing attaching cable and control cord 110 ensure the secure attachment and control of the auxiliary wing. These components are designed to withstand the aerodynamic forces experienced during flight, providing stability and maneuverability. The control surfaces, such as flaps or ailerons 111, enhance the aircraft's maneuverability and stability, allowing for optimization based on airspeed, altitude, and wind conditions. The small eVTOL aircraft fuselage 112 forms the main body of the aircraft, housing the various systems and components necessary for flight. Constructed from lightweight, high-strength materials such as carbon fiber composites or advanced polymers, the fuselage is designed to withstand the stresses of flight while maintaining a low weight for enhanced energy efficiency. The incorporation of smart materials that can alter properties in response to environmental conditions further enhances performance and durability.

The outline of the versatility and adaptability of the eVTOL aircraft system, emphasizing its modular design and the potential for customization. The modular and customizable configurations of the auxiliary wing system allow for adaptation based on mission requirements. Options for different wing sizes, shapes, and functionalities enable the aircraft to perform efficiently across a wide range of missions and conditions. This flexibility also allows for the retrofitting of existing eVTOL models with the auxiliary wing system, enhancing their performance and operational capabilities.

The integration of the auxiliary wing system enhances the aircraft's capabilities, offering improved flight performance and energy efficiency. Meanwhile, the auxiliary wing system's emergency descent functionality provides an additional layer of safety for the eVTOL aircraft. In critical situations where electrical power is low and immediate landing is unfeasible, the wing can transition into an emergency descent mode, acting as a parachute or glide-assist device to reduce descent rates and enable controlled landings. The deployment features can be triggered automatically by onboard systems detecting critical failures or pilot-initiated commands, providing time for the crew to address the situation, potentially saving lives and minimizing damage during critical failures. This feature ensures that the aircraft can maintain stability and control during unexpected situations, further enhancing passenger confidence and operational reliability. The detailed depiction of components such as the vertical take-off propeller, thin-film solar cells, and control mechanisms highlights the innovative approach to energy management and safety. This disclosure serves as a guide for professionals in the field, facilitating the development and optimization of specific embodiments tailored to meet diverse operational requirements and constraints.

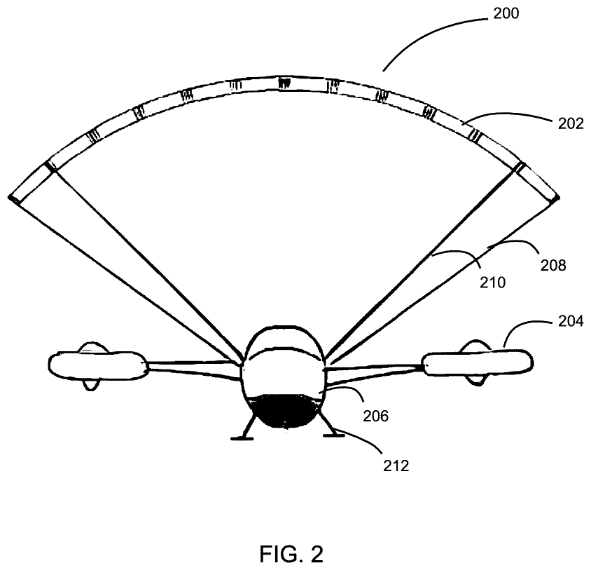

FIG. 2 illustrates a front view of an eVTOL aircraft equipped with a multifunctional auxiliary wing system in its deployed state. The auxiliary wing or glider 202 is shown in its deployed configuration, after the aircraft has taken off, providing aerodynamic lift during horizontal flight, which reduces energy consumption and extends the operational range of the aircraft. The vertical taking off propeller 204 is responsible for the initial vertical ascent, allowing the aircraft to reach a suitable altitude before the auxiliary wing is deployed. The position of the propeller may change during and after the flight taking off vertically, to optimize aerodynamic efficiency and stability. Once the aircraft transitions to horizontal flight, the propeller can be retracted or repositioned to minimize drag. Additionally, the auxiliary wing system may be disengaged or released to accommodate various flight conditions, such as landing or maneuvering in confined spaces or meeting unexpected weather condition. This flexibility provides the aircraft's versatility and efficiency across different phases of flight. The integration of the multifunctional auxiliary wing system with the vertical takeoff propeller allows for transitions between vertical and horizontal flight modes, optimizing performance and energy usage throughout the journey.

The aircraft fuselage 206 houses the main body of the aircraft, providing structural support and housing for passengers and cargo. The auxiliary wing or glider 202 is deployed after the aircraft has achieved vertical ascent. This wing structure is stored compactly during takeoff to avoid interference with the vertical propulsion system. Once deployed, the wing provides aerodynamic lift, allowing the aircraft to glide efficiently using uplifting airflow. The deployment mechanism includes automated actuators or manual controls that ensure a smooth and efficient transition, integrating with the aircraft's flight dynamics.

The vertical taking off propeller 204 is for the eVTOL aircraft's ability to perform vertical takeoff and landing maneuvers. These propellers provide the necessary thrust for vertical ascent, allowing the aircraft to reach an altitude where the auxiliary wing can be deployed. The propellers are designed to work in conjunction with the auxiliary wing system, ensuring that the aircraft can transition smoothly from vertical to horizontal flight. This dual-mode operation enhances the aircraft's versatility, making it suitable for a wide range of applications, from urban air mobility to emergency services. After the auxiliary wing deployed, the propeller s can be rotated to provide forward thrust, enabling efficient horizontal flight. This transition is to optimize speed. The aircraft fuselage 206 serves as the main structural component of the eVTOL aircraft. It houses the cockpit, passenger cabin, and essential systems, providing stability and support for both vertical and horizontal flight operations.

The solar power charging cable 208 is a part of the energy management system, connecting the flexible solar panels integrated into the surface of the auxiliary wing to the aircraft's power systems. These solar panels capture solar energy during flight, contributing additional power to the aircraft's systems and enhancing overall energy efficiency. The onboard energy management system dynamically regulates the distribution of generated electricity to propulsion systems, avionics, and battery storage, optimizing energy harvest and usage based on varying sunlight conditions.

The glider attaching cable and control cord 210 are for the secure attachment and control of the auxiliary wing or glider. These components ensure that the wing is properly aligned and secured to the aircraft during deployment and retraction. The control cord allows for precise adjustments to the wing's position and orientation, enhancing maneuverability and stability during flight. This level of control is for optimizing the aircraft's performance in varying flight conditions, including changes in airspeed, altitude, and wind conditions. The landing gear 212 provides the necessary support for the eVTOL aircraft during takeoff and landing operations. Designed to withstand the stresses of vertical takeoff and landing, the landing gear is constructed from durable materials that ensure reliability and safety.

The auxiliary wing system includes control surfaces such as flaps and ailerons, typically located at the rear position of the auxiliary wing. These control surfaces are for enhancing the maneuverability and stability of the eVTOL aircraft during flight. The flaps and ailerons allow for precise control of the aircraft's flight attitude, enabling it to perform complex maneuvers and maintain stability in various flight conditions. The integration of these control surfaces into the auxiliary wing system ensures that the aircraft can operate efficiently and safely across a wide range of missions and environments.

The wing geometry of the auxiliary wing system is adjustable in-flight, allowing for optimization based on airspeed, altitude, and wind conditions. This feature provides the eVTOL aircraft with the ability to adapt to changing flight conditions, enhancing its performance and efficiency. The adjustable wing geometry allows the aircraft to maintain optimal lift-to-drag ratios, ensuring that it can operate efficiently in both vertical and horizontal flight modes. This adaptability is an advantage of the auxiliary wing system, contributing to the overall energy efficiency and operational range of the eVTOL aircraft.

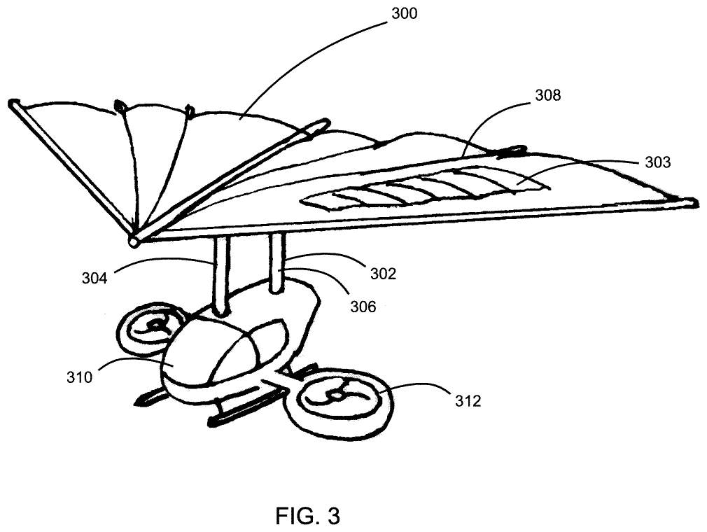

FIG. 3 provides a perspective view of an eVTOL aircraft equipped with a foldable glider wing system in its deployed state according to one embodiment. The foldable glider wing 300 is designed to expand after vertical ascent to provide aerodynamic lift during horizontal flight. This extended wing acts as the fixed wing of the aircraft, reduces the reliance on energy-intensive propellers, thereby lowering energy consumption and extending the aircraft's operational range. The glider wing is supported by fixed columns 302 and 204, which serve multiple purposes: they connect the glider wing to the aircraft, contain electrical wiring 304, and house tubes 306 that allow compressed air to be pumped into the glider wing to fully extend it and maintain the desired aerodynamic shape.

The support column 302 and 304 are for the structural integrity and functionality of the glider wing. These columns not only provide the necessary support to keep the wing stable during flight but also serve as conduits for electrical and pneumatic systems. The electrical wires 304 embedded within these columns are integral to the operation of the flexible solar panels 303, which are mounted on the surface of the glider wing. These solar panels are designed to capture solar energy during flight, contributing additional power to the aircraft's systems. This renewable energy source reduces the aircraft's carbon footprint and operating costs, aligning with the disclosure's emphasis on sustainability and flight energy efficiency. By harnessing solar power, the glider can extend its flight duration and reduce reliance on traditional fuel sources.

The flexible solar panels 303 are enhancing the energy management capabilities of the eVTOL aircraft. These panels are lightweight and aerodynamically efficient, ensuring that they do not hinder the aircraft's performance. The captured solar energy is regulated by an onboard energy management system, with electric wiring system integrated in column 304, which optimizes the distribution of electricity to propulsion systems, avionics, and battery storage. This system dynamically adapts to varying sunlight conditions, ensuring optimal energy harvest and usage throughout the flight.

The compressed air tube 306, housed within the support column 302, plays a role in the deployment and maintenance of the glider wing's aerodynamic shape. By pumping compressed air into the wing, the system ensures that the wing is fully extended and maintains its shape, providing the necessary lift for efficient horizontal flight. This mechanism allows the aircraft to transition smoothly from vertical to horizontal flight, enhancing stability and control.

The eVTOL aircraft 310, as depicted in FIG. 3, is designed to integrate seamlessly with the foldable glider wing system. The aircraft's vertical take-off gear 312 allows for efficient vertical ascent, after which the glider wing deploys to facilitate energy-efficient horizontal flight. This dual-mode capability offers a versatile solution for urban air mobility and other applications where both vertical and horizontal flight capabilities are essential.

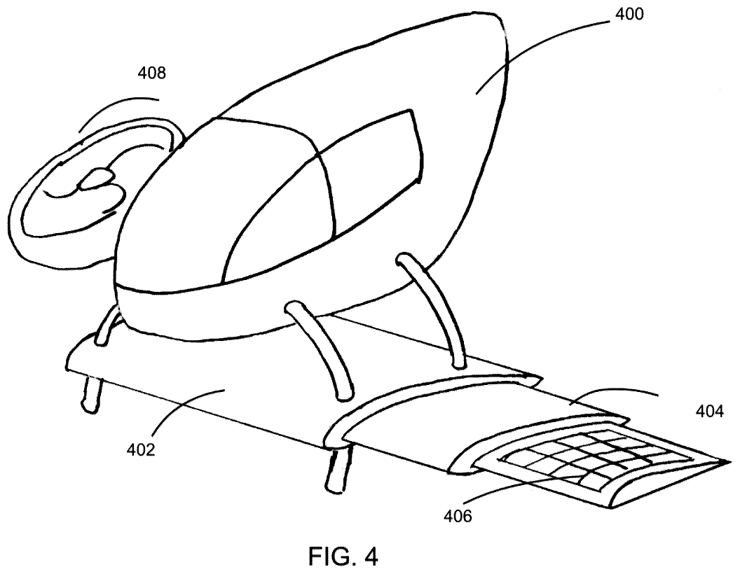

FIG. 4 illustrates a perspective view of another eVTOL aircraft illustrating a retractable auxiliary wing system installed in the landing gear of the aircraft, depicted in its expanded state according to one embodiment. As shown in this embodiment, the wings are telescopically extendable.

The eVTOL aircraft 400 is equipped with an expandable wing system embedding in the landing gear to designed to enhance flight performance and energy efficiency. The fixed wing 402 serves as a storage compartment for the retractable wings, ensuring they remain compact during takeoff and landing phases to avoid interference with vertical propulsion mechanisms. The retractable wing 404, when extended, provides additional aerodynamic lift similar as the fixed wing of an aircraft, facilitating more efficient horizontal flight and reducing energy consumption.

The retractable wing 404 is a component of the auxiliary wing system, designed to extend after vertical ascent. This wing structure is engineered to provide aerodynamic lift during horizontal flight, thereby reducing the reliance on energy-intensive propellers. The deployment mechanism includes automated actuators or manual controls that ensure a smooth transition from vertical to horizontal flight, maintaining the aircraft's stability and control. This innovative design allows the eVTOL aircraft to glide more efficiently, significantly lowering energy consumption and extending its operational range.

Integrated into the surface of the retractable wing 404 are flexible solar panels 406. These panels capture solar energy during flight, contributing additional power to the aircraft's systems and enhancing overall energy efficiency. The onboard energy management system dynamically regulates the distribution of generated electricity to propulsion systems, avionics, and battery storage. This system adapts to varying sunlight conditions, optimizing energy harvest and usage, thereby reducing the aircraft's carbon footprint and operating costs.

The vertical take-off propeller 408 is for the initial ascent phase of the e VTOL aircraft. It provides the necessary thrust for vertical lift-off, allowing the aircraft to reach a suitable altitude before the auxiliary wing system is deployed. The propellers 408 could rotated after extended wing deployed to provide horizontal thrust for speed during the flight. The integration of the vertical take-off propeller with the retractable wing system exemplifies the multifunctional design of the aircraft, enabling seamless transitions between different flight modes and enhancing overall operational flexibility.

In addition to its energy efficiency and operational flexibility, the auxiliary wing system includes an emergency descent mode, providing an additional layer of safety. In situations where electrical power is low and immediate landing is unfeasible, the wing can act as a glide-assist device, reducing descent rates and enabling controlled landings. This emergency capability is automatically triggered by onboard systems detecting critical failures or can be initiated by pilot commands, offering time for the crew to address the situation and potentially saving lives.

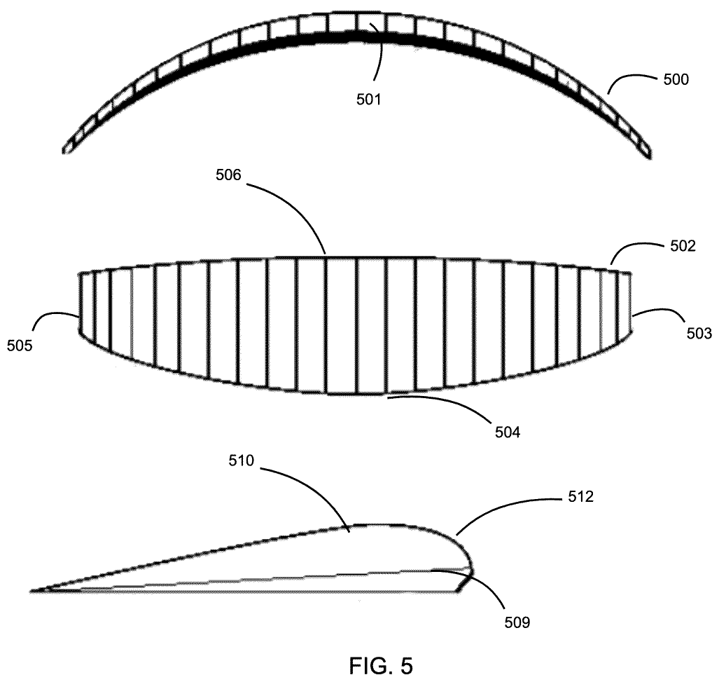

FIG. 5 illustrates the different views of the auxiliary glider wing in its expanded state, according to one embodiment. The figure provides a comprehensive view of the auxiliary wing system, showcasing its front, top, and cross-sectional perspectives. The front view 500 highlights the overall structure of the extended glider wing, while the top view 502 offers insights into the aerodynamic design, including the right ear 505 and left ear 503 of the top view. The leading edge 504 and trailing edge 506 are contributing to the wing's aerodynamic efficiency. Flaps are installed at the rear end of the wing 506 shown in their deployed position, enhancing aerodynamic control of the glider. The cross-sectional view 510 provides a detailed look at the wing's internal structure, emphasizing the leading edge 512, the support struts 509 and the material composition, which contributes to the wing's strength and flexibility.

The auxiliary wing system, as depicted in FIG. 5 allows the wing to function as a parachute or glide-assist device during critical failures, enabling controlled landings. The emergency descent capability provides an additional layer of safety by reducing descent rates and allowing for a controlled approach to landing. This feature is automatically triggered by onboard systems detecting critical failures or can be initiated by pilot commands, ensuring rapid deployment in emergency situations. The ceiling open 501 label in FIG. 5 indicates the mechanism for improved stability of the glider wing during operation. This ceiling opening integration ensures the position of the auxiliary glider wing remains stable and balanced.

The right ear 505 and left ear 503 of the top view in FIG. 5 are integral to the wing's aerodynamic design. These components help stabilize the wing during deployment and flight, contributing to the overall aerodynamic efficiency. The leading edge 504 and trailing edge 506 are shaped to maximize lift-to-drag ratios, enhancing the aircraft's performance during horizontal flight. These design elements ensure that the wing provides optimal lift while minimizing drag.

The cross-sectional view 510 in FIG. 5 offers a detailed examination of the wing's internal structure, highlighting the leading edge 512. This view is for understanding how the wing alleviates aerodynamic forces during flight. The internal structure is constructed from lightweight, high-strength materials such as carbon fiber composites or advanced polymers, ensuring durability and performance. The use of smart materials that can alter properties in response to environmental conditions further enhances the wing's structural integrity and adaptability.

In practical applications, the auxiliary wing system's emergency descent mode is particularly beneficial for urban air mobility, cargo delivery, and emergency services. In urban environments, where space is limited, the ability to perform controlled landings in emergency situations is invaluable. For cargo delivery, the extended range and energy efficiency provided by the auxiliary wing system enable longer flights with reduced energy consumption. In emergency services, such as medical evacuations or disaster response, the safety features of the auxiliary wing system ensure rapid and secure deployment, potentially saving lives and minimizing damage.

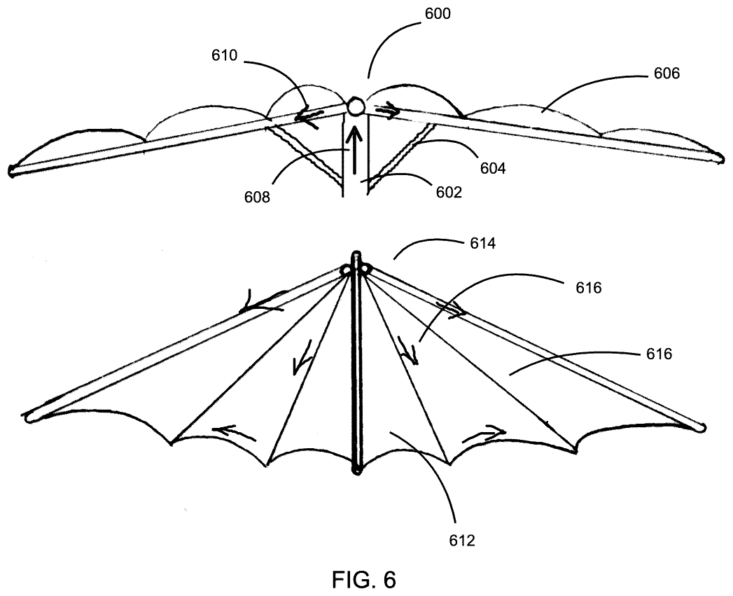

FIG. 6 illustrates the front and top views of the foldable hang glider of the eVTOL aircraft in its expanded state, according to one embodiment. This figure provides a visualization of the auxiliary wing system. The front view, labeled as 600, showcases the opened hang glider, highlighting its structural design and aerodynamic profile. The support column, labeled as 602, connects the hang glider to the aircraft, ensuring stability and structural integrity during deployment and flight. This support column is for maintaining the alignment and balance of the glider relative to the aircraft's body. During deployment or extension of the hang glider in mid of the flight, compressed air flow through support column 602 to assist in the rapid inflation of the wing structure.

The additional support labeled as 604 is designed to support the glider, providing the necessary tension and rigidity to maintain its shape during flight. This support mechanism is integral to the deployment process, ensuring that the glider unfurls smoothly and efficiently. The inflated surface, labeled as 606, is a feature that enhances the aerodynamic properties of the glider, allowing it to capture and utilize airflow effectively for lift generation. This surface is designed to be lightweight yet durable, contributing to the overall efficiency of the eVTOL aircraft.

The forced air system, indicated by label 608, plays a role in opening the hang glider. This system utilizes controlled airflow to assist in the deployment of the glider, ensuring a rapid and reliable transition from a compact to an expanded state. The airflow direction, labeled as 610, is strategically managed to optimize the deployment process and maintain the aerodynamic efficiency of the glider. This forced air system provides a mechanical advantage in the rapid and stable deployment of the auxiliary wing.

The top view of the opened hang glider, labeled as 612, provides a detailed perspective of the glider's layout and surface area. This view highlights the leading edge, labeled as 614, which is designed to minimize drag and maximize lift during horizontal flight. The leading edge is designed to ensure the aerodynamic performance of the glider, influencing the lift-to-drag ratio and overall flight efficiency. The airflow direction of the forced air, labeled as 616, is controlled to ensure rapid expanding of individual cells within the glider's structure. This controlled airflow enhances stability and responsiveness, allowing for smoother maneuverability and improved performance and stability in various wind conditions.

The integration of flexible solar panels on the surface of the hang glider 616, helps the energy efficiency for eVTOL aircraft. These solar panels are built with lightweight and flexible materials that can conform to the aerodynamic shape of the glider, allowing for optimal energy capture without adding significant weight. The flexible solar panels capture solar energy during flight, contributing additional electrical power to the aircraft's systems. The use of flexible solar panels ensures that the glider remains lightweight and aerodynamically efficient while providing a renewable energy source, reducing the aircraft's carbon footprint and operating costs.

The auxiliary wing system, as depicted in FIG. 6, is integrated with the aircraft's flight control systems, allowing for advanced monitoring and adjustment capabilities. This integration enables sensors and AI algorithms to continuously monitor flight parameters, such as airspeed, altitude, and wind conditions, and adjust the wing deployment and configurations for optimal performance. This intelligent control system enhances the safety, efficiency, and versatility of the eVTOL aircraft, allowing it to adapt to varying flight conditions and mission requirements.

The multifunctional auxiliary wing system offers several advantages, including enhanced energy efficiency by reducing reliance on propellers during horizontal flight, improved safety through emergency descent capabilities, and operational flexibility with adjustable wing configurations. The modular design of the wing system allows for customization based on mission requirements, enabling the aircraft to perform efficiently across a wide range of applications, from urban air mobility and cargo delivery to emergency services and military operations.

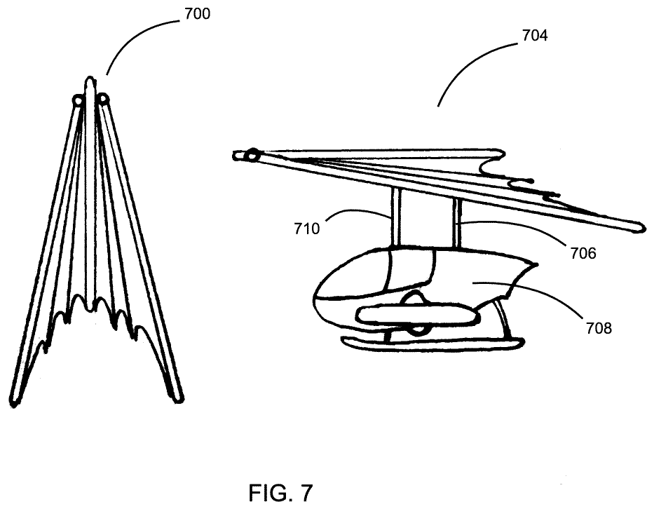

FIG. 7 illustrates a modular and customizable configuration of the foldable hang glider in the closed position, installed on top of an eVTOL aircraft through two support columns. This version highlights the flexibility and adaptability of the auxiliary wing system, enabling seamless integration with mission-specific options across different aircraft types. The support columns provide stability and ensure secure attachment, while the foldable nature of the hang glider enables compact storage and efficient deployment. The left image in FIG. 7 provides a top view of the hang-glider in its closed state, labeled as 700, while the right image shows the closed hang glider installed on top of the eVTOL aircraft, labeled as 704. The support columns, labeled as 706 are providing structural stability and housing essential components such as electrical wires and tubes for forced air, as indicated by label 710. The e VTOL aircraft itself is labeled as 708.

The top view of the hang-glider in the closed position, labeled as 700, highlights the compact and efficient design of the auxiliary wing system. This design ensures that the wing does not interfere with the vertical propulsion mechanisms during takeoff and landing phases. The compact storage of the wing is for maintaining the aerodynamic profile of the aircraft and minimizing drag during vertical ascent and descent. The installation of the hang glider on top of the eVTOL aircraft, as shown in the right image and labeled as 704, demonstrates the integration of the auxiliary wing system with the aircraft's existing structure. The support columns, labeled as 706 can provide a secure attachment point for the wing while also serving as conduits for electrical and pneumatic systems, also serve as multifunctional conduits, as indicated by label 710. These columns are designed to withstand the aerodynamic forces encountered during flight, ensuring the stability and reliability of the auxiliary wing system.

The hang-glider wing structure can be in modulated form, can be detached and reattached as needed, allowing for easy maintenance and customization based on specific flight requirements. This modularity also facilitates quick repairs or replacements, minimizing downtime for the eVTOL aircraft. The materials used in the wing construction are lightweight yet durable, contributing to the overall efficiency and performance of the aircraft. The integration of advanced materials and design techniques ensures that the auxiliary wing system enhances the eVTOL's capabilities without compromising safety or functionality. The modular sections of the wing can be tailored to different sizes, shapes, and functionalities, providing the aircraft with the adaptability needed to meet diverse challenges and opportunities in urban air mobility, cargo transport, and emergency response.

The auxiliary wing system's adaptability allows it to be tailored for various mission profiles, we can attach different auxiliary wing configurations to optimize performance for specific tasks. This flexibility makes the system suitable for a wide range of applications, from urban air mobility to search and rescue operations. By allowing for different wing setups, the eVTOL can be customized to meet the demands of diverse environments and operational requirements, enhancing its versatility and utility in the field.

The eVTOL aircraft, labeled as 708, serves as the platform for the auxiliary wing system. This aircraft is designed to benefit from the enhanced flight performance, energy management, and safety features provided by the auxiliary wing. By incorporating the modular and customizable wing system, the eVTOL aircraft can be adapted for various mission requirements with the ability to retrofit existing eVTOL models with this system further extending its applicability and potential impact on the aviation industry.

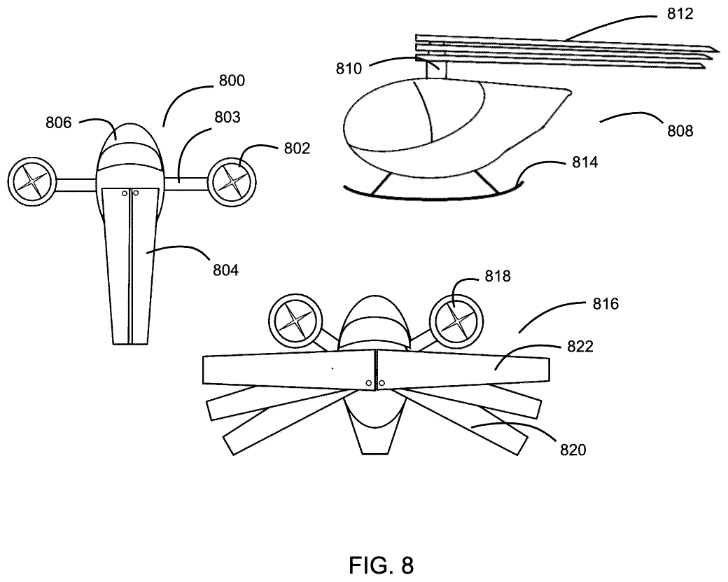

FIG. 8 illustrates various views of an eVTOL aircraft equipped with stacked folding wings according to one embodiment, showcasing its flexible multifunctional design for different expandable wing types. The figure includes three distinct perspectives: the top view of the aircraft with folding wings in a closed position 800, the top view with folding wings fully extended 816, and the side view with folding wings in a closed position 808.

In the top view shown as 800, the eVTOL aircraft is depicted with its stacked folding wings in a closed position. The stacked folding wings, identified as 804 can comprise multiple sub-wings stacked together while not in action, are securely attached to the fuselage 806 through the wing struts 810. The main propeller 802 is displayed in the takeoff position, with the propeller arm 803 extended perpendicular to the fuselage of the aircraft. The propeller arms provide structural support and facilitate precise control of the propeller's orientation during vertical flight. The propellers can be rotated during the transition from vertical to horizontal flight, allowing the aircraft to achieve efficient forward propulsion. This rotation is controlled by an advanced mechanism that ensures smooth and seamless movement, optimizing aerodynamic performance and energy efficiency.

Additionally, the eVTOL's design incorporates an automated control system that manages the transition phases. This system continuously monitors flight parameters and adjusts the wing and propeller configurations as needed. The integration of sensors and real-time data processing allows the aircraft to adapt to changing conditions, enhancing its responsiveness and reliability.

The side view of the stacked folding wings system, labeled as 808, provides details on the eVTOL's configuration with folding wings in the closed position. The fuselage 806 forms the central structure of the aircraft, housing components such as propulsion systems and avionics. The wing struts 810, as seen from this angle, serve as attachment points for the folding wings, maintaining their stability and alignment during flight operations. Below the fuselage, the landing skids 814 are visible, providing a base for the aircraft during takeoff, landing, and ground operations.

In the top view with the stacked folding wings fully extended, identified as 816, the aircraft demonstrates its transition from vertical to horizontal flight. The stacked folding wings 804 are shown in their extended position with three sub-wings on each side as an example, which increases the total wing surface area and enhancing the aerodynamic lift during horizontal flight. The main propeller 818 is repositioned to a forward orientation when folding wings are extended, optimizing thrust and facilitating the aircraft's transition to forward motion. The deployment of the folding sub-wings is enabled by precise actuators integrated into the wing struts 810, ensuring seamless extension and retraction during different phases of flight. Further details are shown in the stacked folding wings extended view, labeled as 820, where three folding sub-wings 804 displayed in their fully expanded state.

The top view, labeled as 822, highlights the integration of flexible solar panels on the surface of each folding sub-wings 804. These solar panels are designed to capture solar energy during flight, contributing additional power to the aircraft's systems and reducing its reliance on onboard battery storage.

The side view with folding wings in a closed position, identified as 812, provides insight into the compact structural design of the aircraft during vertical operations. The folding stack wings 804, when retracted, align closely with the fuselage 806, minimizing the aircraft's footprint and allowing it to operate efficiently in confined urban environments. The landing skids 814 are engineered to withstand the forces of vertical takeoff and landing while ensuring stability and safety during ground contact.

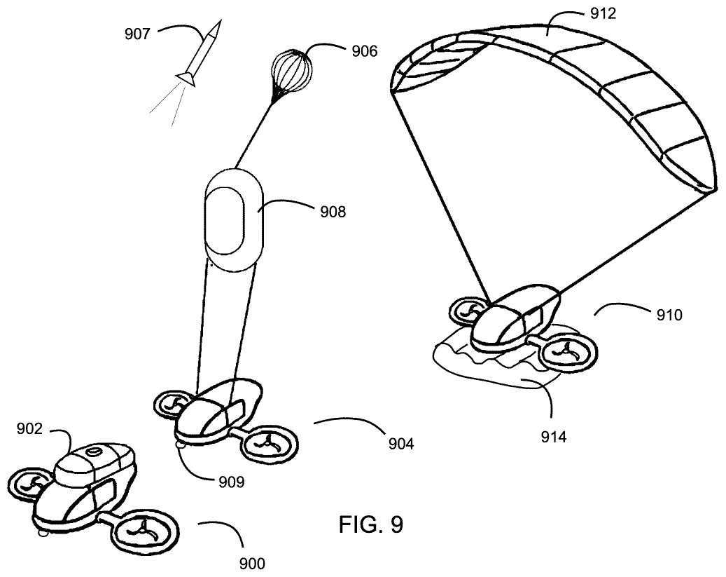

FIG. 9 illustrates the different stages of deploying the auxiliary parachute wing in an eVTOL aircraft, highlighting the transition from its initial state to a fully deployed and stable position. The initial state 900 represents the parachute wing in its folded position, securely stored within a package 902 above the aircraft. This compact storage ensures that the wing does not interfere with the aircraft's vertical propulsion during takeoff and landing phases, aligning with the disclosure's goal of maintaining operational efficiency and safety.

The deployment process begins with step 904, where the pilot parachute 906 is activated. This smaller parachute initiates the deployment by dragging the parachute wing package out of the aircraft. The pilot parachute's role is to ensure a controlled and gradual release of the main parachute wing, preventing any abrupt changes in the aircraft's flight dynamics.

Upon deployment of the pilot parachute, the parachute wing package 908 disengages from its storage compartment. This disengagement facilitates the unfurling of the parachute wing. The configuration of the package and the materials utilized are structured to promote a seamless separation, the tension on the lines is carefully managed to reduce the likelihood of entanglement among components within the system and minimizing any disruptions to the aircraft's flight trajectory.

Another step 910 involves the parachute wing reaching its stable position, fully opened 912. In this state, the wing provides the necessary aerodynamic lift to support horizontal flight, significantly reducing the reliance on energy-intensive propellers. This deployment not only enhances energy efficiency but also extends the operational range of the eVTOL aircraft, aligning with the objectives of some embodiments of the present disclosure.

In some embodiments, the parachute wing or canopy can double as an emergency parachute, such as by deploying the flexible canopy ballistically using a small rocket engine, such as “Ballistic Recovery System (BRS)” to expend the canopy quickly in case of an engine failure during the eVTOL mode for lack of gliding capabilities. The control of the parachute deployment can be automated to ensure timely activation, and avoid potential human error during critical situations. This automation can be integrated with the aircraft's onboard systems to monitor flight conditions and trigger deployment when necessary. The automation system can use sensors and algorithms to assess parameters such as altitude, speed, and engine performance. By continuously analyzing these data points, the system can make real-time decisions to deploy the parachute when it detects a significant risk of failure. Additionally, the system can be designed to override manual controls if it determines that immediate deployment is essential for safety. This ensures that the parachute is deployed optimally, minimizing the risk of injury or damage. Meanwhile the inflatable landing gear can provide additional cushioning upon impact, further enhancing safety during emergency landings. This gear can automatically inflate when the parachute is deployed, absorbing shock and reducing the likelihood of structural damage to the aircraft, or the inflation can be triggered when the system detects an imminent landing. This dual-trigger mechanism ensures that the landing gear is ready to provide maximum protection regardless of the specific emergency scenario.

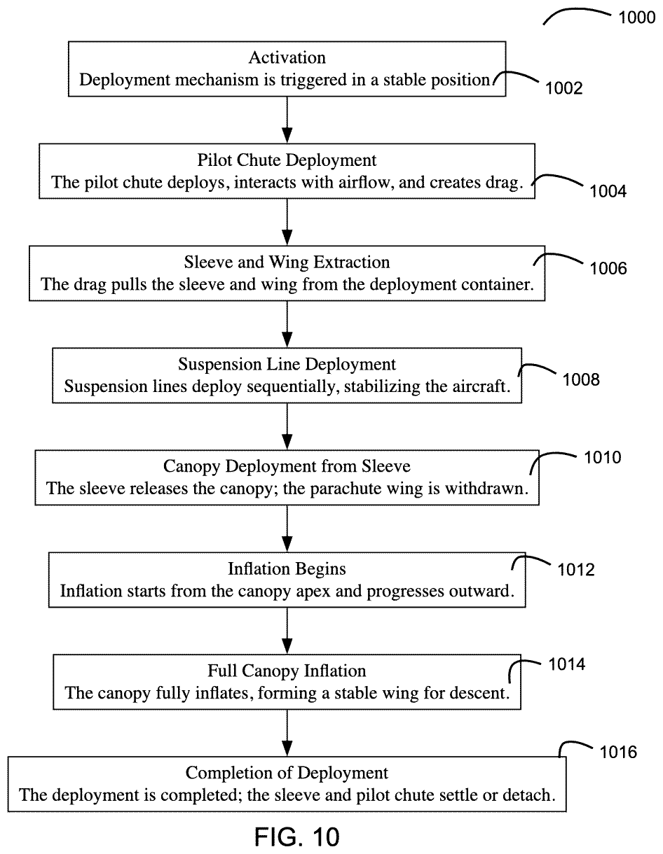

FIG. 10 presents a flowchart 1000 illustrates the sequential steps involved in the deployment process of a parachute wing intended for aircraft. Each step is annotated with a reference number corresponding to specific stages of the deployment process, thereby facilitating a consistent and dependable operation of the parachute system. Each labeled step 1002, 1004, 1006, 1008, 1010, 1012, 1014, and 1016 represents a distinct phase in the deployment process, ensuring safety, reliability, and aerodynamic performance. This structured methodology minimizes risks associated with deployment failures and optimizes the functionality of the wing during operation. Each phase, from activation to full canopy inflation, is designed to minimize risks and optimize performance. By following these structured steps, the system enhances reliability and safety during deployment, ultimately supporting the aircraft's maneuvering capabilities.

Step 1: Activation 1002. The process is initiated with the activation of the deployment mechanism. This activation is a coordinated procedure that occurs when the aircraft is in a stable and controlled position, ensuring conditions are suitable for the deployment of the parachute. The stability of the aircraft provides an environment conducive to the deployment sequence proceeding without complications. Upon initiation, the activation triggers the release of a series of components necessary for the continuation and completion of the deployment sequence. Each component has a specific function, and timely release is integral to the overall deployment process.

Step 2: Pilot Chute Deployment 1004. Subsequent to the activation of the parachute system, the next phase involves the deployment of the pilot chute. This component is released into the airstream, where it engages with the surrounding airflow to create drag. This drag serves as the initial anchor for the parachute system. By generating drag, the pilot chute provides the force necessary to stabilize the parachute system and initiates the extraction of the main parachute package and other components. This process ensures that the parachute pulled away from the aircraft smoothly, preparing for the expansion of the glider wing system. The pilot chute's interaction with the airflow is a step in the deployment sequence, contributing to the operation of the parachute wing system.

Step 3: Sleeve and Wing Extraction 1006. In this phase of the parachute deployment process, the drag generated by the pilot chute facilitates the extraction of both the protective sleeve and the folded parachute wing from the deployment container. The pilot chute, acting as an auxiliary parachute, creates sufficient drag force to initiate the extraction sequence. This step is designed to ensure that the wing structure is released in a controlled manner, reducing the risk of potential entanglements or irregular deployment. The controlled release maintains the integrity of the wing's deployment, ensuring that it unfurls smoothly and symmetrically, thereby optimizing its performance and enhancing the safety of the deployment.

Step 4: Suspension Line Deployment 1008. As the sleeve is extracted from its housing, the suspension lines are deployed in a precise and sequential manner. This sequence ensures that the attachment points of the parachute wing are extended in a controlled fashion. By deploying the lines in this order, the risk of tangling is reduced, which is necessary for the operation of the parachute system. This organized deployment minimizes the probability of entanglement and contributes to the stabilization of the aircraft during the deployment process. The controlled extension of the parachute wing's attachment points allows for a smooth transition, enhancing the safety and reliability of the deployment mechanism.

Step 5: Canopy Deployment from Sleeve 1010. Once the suspension lines have been extended, the next phase in the parachute deployment sequence begins. At this point, the closure mechanism of the sleeve, which holds the parachute wing in its compact state, is triggered to open. This release process is designed to ensure that the parachute wing is freed smoothly without tangling or obstruction. As the closure mechanism disengages, the folded parachute wing is released from the sleeve. This marks the beginning of its transformation from a compact bundle into its expanded configuration. The transition from compactness to expansion sets the stage for the subsequent inflation of the parachute. During this phase, the wing begins to unfurl, spreading out and taking shape in the air. This expansion process allows the parachute to achieve the form necessary for optimal performance, ensuring readiness for the inflation that will provide the drag to slow the descent effectively.

Step 6: Inflation Initiation 1012. Once the parachute canopy has been cleared from its protective sleeve, the process of inflation begins. This stage is necessary for the deployment and functioning of the parachute glider wing. The inflation process is initiated at the apex of the parachute wing and progresses outward toward the edges of the canopy. This phased approach to inflation is designed to ensure that the expansion of the parachute wing occurs symmetrically. Such symmetry helps maintain the aerodynamic stability of the parachute as it deploys. By expanding evenly, the parachute can manage the forces acting upon it, providing a controlled descent. This orchestration of the inflation process is to ensure the parachute to perform its function safely and efficiently.

Step 7: Full Canopy Inflation 1014. In this phase, the parachute glider wing undergoes complete inflation, transforming into a fully expanded and stable aerodynamic surface. This step ensures that the parachute wing is capable of providing the lift and drag forces required for a controlled descent or forward movement. The complete inflation of the canopy maintains stability and control during the descent, allowing for maneuverability and adherence to operational requirements. The fully inflated canopy creates an aerodynamic profile, for achieving the desired performance, whether it be a controlled descent to a landing zone or a forward glide. This stage is designed to ensure that the parachute operates efficiently and safely, adapting to the needs of the mission or activity.

Step 8: Completion of Deployment 1016. The deployment sequence concludes as the sleeve and pilot chute either settle onto the fully inflated canopy or detach and fall away, depending on the design specifications of the parachute system. At this juncture, the parachute wing has achieved full inflation and is operational. It is designed to provide support for the aircraft, ensuring a controlled descent through the atmosphere. The parachute's structure and materials are engineered to withstand the forces encountered during descent, allowing for maneuvering if required. This stage marks the deployment of the parachute, signifying readiness to perform its function of lowering the aircraft to the ground or guiding it through aerial maneuvers. The entire deployment process, from activation to full inflation, is designed to ensure reliability and safety, culminating in this moment where the parachute is engaged and functioning as intended. Once the deployment is completed, the propeller of the aircraft can rotate to provide forward thrust, assisting in steering and stabilizing the descent.

In further embodiments of the present disclosure, the auxiliary wing system incorporates piezoelectric materials and small wind turbines to generate supplemental electricity during flight. These technologies harness the natural vibrations and airflow experienced by the aircraft to produce electrical energy, contributing to a more sustainable and energy-efficient operation. By integrating these energy-harvesting devices strategically into the aircraft's design, the system leverages unused kinetic energy to power onboard systems and reduce reliance on traditional fuel sources or stored battery energy.

In one embodiment, the integration of piezoelectric materials into the wing structure facilitates the generation of electrical energy from vibrations encountered during flight. This configuration utilizes the vibrational energy experienced by the wing, converting it into electrical energy. This energy generation method operates in conjunction with flexible solar panels incorporated into the wing, thereby contributing to the aircraft's energy efficiency and reducing its carbon emissions.

Piezoelectric materials serve as essential components within the energy-harvesting subsystem of the auxiliary wing system. These materials exhibit the capability to convert mechanical energy into electrical energy through the direct piezoelectric effect. Specifically, when subjected to mechanical stress, such as compression, stretching, or vibrations, piezoelectric materials produce an electrical charge across their surfaces. This characteristic renders them effective in capturing vibrational energy generated during flight.

Piezoelectric Materials for Vibration Energy Harvesting: Piezoelectric materials are incorporated into specific regions of the wing structure where mechanical vibrations are most prominent during flight. These materials convert mechanical strain caused by airflow-induced vibrations into electrical energy through the piezoelectric effect. For example, thin layers of piezoelectric films can be embedded along the trailing edges of the auxiliary wing or within areas experiencing high-frequency oscillations. The generated electricity is collected by a network of micro-circuits and directed to an onboard energy management system. This harvested energy can then be used to supplement power for avionics, lighting, or auxiliary systems, enhancing overall efficiency without adding significant weight or complexity to the aircraft.

Furthermore, the incorporation of small wind turbines within the wing structure provides an additional mechanism for energy generation. These turbines exploit the airflow encountered during flight, converting kinetic energy into electrical power. This feature is integrated into the aircraft's energy management system and demonstrates the disclosure's utilization of renewable energy sources. The combination of solar panels, piezoelectric materials, and wind turbines establishes a comprehensive energy generation system, adaptable to varying flight conditions. Small Wind Turbines for Airflow Energy Conversion: Small wind turbines are integrated into the auxiliary wing system or fuselage at locations optimized for airflow dynamics. These turbines are compact, lightweight, and designed to operate efficiently even at high altitudes where airflow conditions may vary. In one embodiment, turbines are placed within streamlined housings on the upper surface of the wing, where airflow velocity is highest. The small wind turbine can be also placed on the tail section of the aircraft, where they can take advantage of the airflow generated by the aircraft's movement. This placement ensures minimal drag and maximizes energy capture, contributing to the aircraft's auxiliary power needs without significantly impacting its aerodynamic performance. These turbines capture the kinetic energy of the airflow and convert it into electrical power via high-efficiency generators. The generated electricity is then fed into the aircraft's power system, reducing the load on primary energy sources and extending operational range.

Dynamic Optimization with Smart Sensors: The energy-harvesting devices are equipped with smart sensors and control systems to optimize their performance under varying flight conditions. For instance, piezoelectric materials may adjust their orientation or sensitivity to match the frequency and amplitude of wing vibrations. Similarly, wind turbines can employ variable-pitch blades to maintain peak efficiency across a range of airspeeds. These adjustments are controlled by an onboard microcontroller that continuously monitors flight parameters, such as airspeed, altitude, and turbulence. By dynamically adapting to real-time conditions, the system ensures maximum energy generation while minimizing any potential impact on aerodynamic performance.

Integration with Lightweight Materials: Advancements in lightweight and durable materials further enhance the feasibility of these energy-harvesting technologies. For example, piezoelectric materials can be fabricated using nanostructures or composites, reducing their weight while maintaining high energy-conversion efficiency. Similarly, wind turbines are constructed from advanced polymers or carbon-fiber-reinforced composites to ensure minimal impact on the aircraft's weight and drag. These materials are carefully chosen to integrate seamlessly with the aerodynamic profile of the auxiliary wing system.

Efficient Energy Storage and Utilization: The electricity generated by piezoelectric materials and wind turbines is stored in high-efficiency battery systems onboard the aircraft. These batteries are designed to provide immediate power to critical systems or store excess energy for later use. The energy management system dynamically prioritizes electricity distribution based on operational needs, such as propulsion, avionics, or lighting. This approach not only reduces energy wastage but also ensures consistent power availability throughout the flight.

Sustainability and Environmental Impact: This innovative use of energy-harvesting technologies aligns with global efforts to reduce carbon emissions and promote cleaner energy solutions in transportation. By reducing reliance on traditional fuel sources and maximizing the utilization of renewable energy during flight, the system lowers the environmental footprint of eVTOL aircraft. This sustainable design supports the development of greener urban air mobility solutions, contributing to broader objectives in energy conservation and environmental stewardship.

Various embodiments of the disclosure described herein pertain to a novel advancement in electric vertical take-off and landing (eVTOL) aircraft technology, specifically focusing on a multifunctional, energy-efficient auxiliary wing system. This system is designed to enhance flight performance, energy management, and safety features of eVTOL aircraft, which are increasingly becoming a transformative force in urban and regional air transportation. Traditional eVTOL designs rely heavily on propellers or rotors for both vertical lift and horizontal flight, which can be energy-intensive and limit range and efficiency. The disclosure addresses these challenges by introducing an auxiliary wing system that reduces energy consumption during sustained flight and improves operational versatility.

Motion sickness is caused by a disconnect between the sensory signals received by the inner ear, eyes, and body, leading to confusion in the brain. Since the brain receives conflicting information, it struggles to interpret the body's movement, resulting in symptoms like nausea, dizziness, and sweating. To alleviate motion sickness, individuals can try focusing on the horizon, taking deep breaths, or using over-the-counter medications like antihistamines. Additionally, sitting in a stable position and avoiding reading or screen time can help reduce symptoms. However, often time the passengers do not have the opportunities to implement these strategies effectively, especially in crowded or confined spaces.

The present disclosure describes systems and methods for mitigating motion sickness through tactile feedback and active participation. The disclosure is detailed in terms of both structure and function, as illustrated in the accompanying descriptions and figures. Various embodiments are disclosed, and it should be understood that different components, configurations, and features described herein may be interchanged, combined, or modified to suit different applications, all within the scope of the disclosure. While certain implementations are explicitly illustrated, it is expressly contemplated that features from one embodiment may be integrated into another where applicable.

The described embodiments are not intended to be exhaustive or restrictive but rather illustrative of the principles underlying the disclosure. The disclosure provides a non-visual approach to motion sickness mitigation by leveraging haptic or tactile feedback mechanisms that assist the brain in resolving sensory mismatches between the vestibular and proprioceptive systems. The disclosed embodiments, including wearable devices and interactive participation systems, illustrate different applications of the core technology, ensuring broad applicability across various transportation, virtual reality, and healthcare environments.

This disclosure enables those skilled in the art to recognize that the integration of motion-sensing technologies-such as gyroscopes, GPS, radar, and LIDAR-into wearable devices enhances real-time adaptation to movement, improving the effectiveness of the tactile feedback system. Additionally, artificial intelligence algorithms can further refine feedback delivery by predicting motion patterns and preemptively generating cues, optimizing the synchronization of sensory inputs. While specific configurations are detailed herein, it should be understood that modifications and variations can be made without departing from the spirit and scope of the disclosure.

The disclosure also contemplates user participation in motion simulation as a means to mitigate motion sickness, drawing inspiration from the observation that active drivers rarely experience such discomfort. The disclosed interactive device allows users to engage with predicted vehicle movements, aligning their physical responses with anticipated motion, thereby reducing sensory conflict. Various implementations of this interactive system are described, including handheld controllers, vehicle-integrated interfaces, and virtual-reality-based simulators. The scope of this disclosure extends to multiple practical applications, including commercial and personal transportation, virtual reality experiences, and medical or rehabilitation use cases. This disclosure aims to enable others skilled in the art to implement and adapt these principles for various needs, ensuring flexibility and broad applicability. Any modifications, enhancements, or alternative configurations that align with the fundamental principles disclosed herein are intended to be encompassed within the scope of the claims.

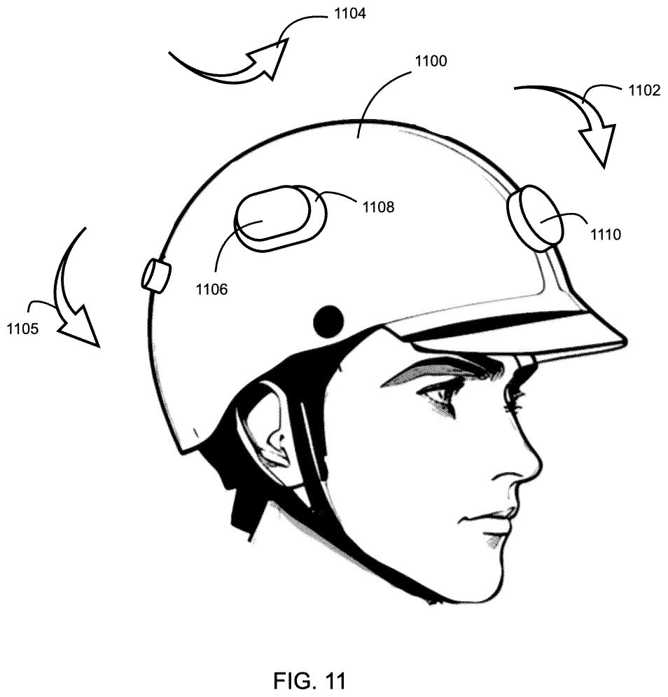

FIG. 11 illustrates a Haptic/Tactile Feedback System integrated into a wearable device, such as a helmet or headband, designed to mitigate motion sickness by delivering haptic feedback signals that simulate motion. The system comprises several components, such as the helmet 1100 is equipped with an integrated tactile feedback mechanism that provides subtle tactile signals to the user. These signals are designed to simulate head movements, such as vertical movement 1102, spiral movement 1104, and horizontal movement 1105, thereby assisting in reconciling sensory inputs from the vestibular and proprioceptive systems.

The computing device 1106 attached to the helmet can be responsible for processing data gathered from various sensors. This device can interpret environmental changes and generating precise tactile feedback. The computing device can be programmed to utilize data from gyroscopes, GPS receivers, and other motion-detecting technologies to predict and simulate motion, enhancing the system's effectiveness in reducing motion sickness. This integration allows the system to function independently of visual input, making it particularly beneficial for individuals who are visually impaired or in situations where visual cues are unavailable.

The vehicle or airplane serves as a power source. The rechargeable battery pack 1108 is configured to maintain the operational status of the tactile feedback system for prolonged durations by supplying power to the haptic motors and sensors. This configuration ensures consistent and reliable performance in scenarios where the wired power source is disconnected. The battery pack is specifically designed to be lightweight and compact, thereby reducing any additional load on the user when the helmet or headband is worn. The wireless signal receiving device 1110 enables the system to communicate with external devices and sensors, allowing for real-time data exchange and updates. This capability is for integrating the tactile feedback system with other technologies, such as artificial intelligence modules that predict vehicle movements and provide early alerts to users. By leveraging wireless communication, the system can continuously adapt to changing environmental conditions, ensuring that the tactile feedback remains accurate and effective in mitigating motion sickness.

The tactile feedback system can address the sensory conflicts between the vestibular and proprioceptive systems, which are often responsible for motion sickness. By delivering tactile signals that simulate motion, the system helps the brain align sensory inputs, reducing the likelihood of sensory mismatches that lead to motion sickness. This approach is particularly innovative as it does not rely on visual input, making it suitable for a wide range of applications, including transportation, virtual reality, and healthcare.

In transportation, the tactile feedback system can be integrated into various vehicles, such as cars, airplanes, and boats, to enhance passenger comfort. By providing non-visual cues that simulate motion, the system can help passengers, especially those who are visually impaired, to better anticipate and adapt to changes in movement, reducing the incidence of motion sickness. This application is particularly valuable in public transportation systems, where passengers may not have access to visual cues to resolve sensory conflicts.

In the realm of virtual reality and gaming, the tactile feedback system can be implemented in VR headsets and gaming chairs to reduce motion sickness during immersive experiences. By simulating motion through tactile signals, the system can help users maintain a sense of balance and orientation, enhancing the overall experience and reducing the likelihood of motion-induced discomfort. This application is especially beneficial for users who are sensitive to motion sickness or who engage in prolonged VR sessions.

In healthcare and rehabilitation, the tactile feedback system can be used in therapeutic settings to assist patients with balance disorders or vestibular dysfunctions. By providing non-visual cues that simulate motion, the system can aid in the rehabilitation process, helping patients improve their balance and coordination. This application is particularly advantageous for individuals undergoing therapy for conditions that affect their vestibular system, offering a novel approach to treatment that does not rely on visual input.

Overall, the tactile feedback system offers a solution to mitigating motion sickness by addressing the sensory conflicts that lead to discomfort. Its ability to function independently of visual input makes it a versatile and effective tool for a wide range of applications, providing a more comfortable and enjoyable experience for users in various environments. By leveraging tactile signals to simulate motion, the system effectively synchronizes the body's sensory inputs, offering a novel approach to managing motion sickness symptoms.

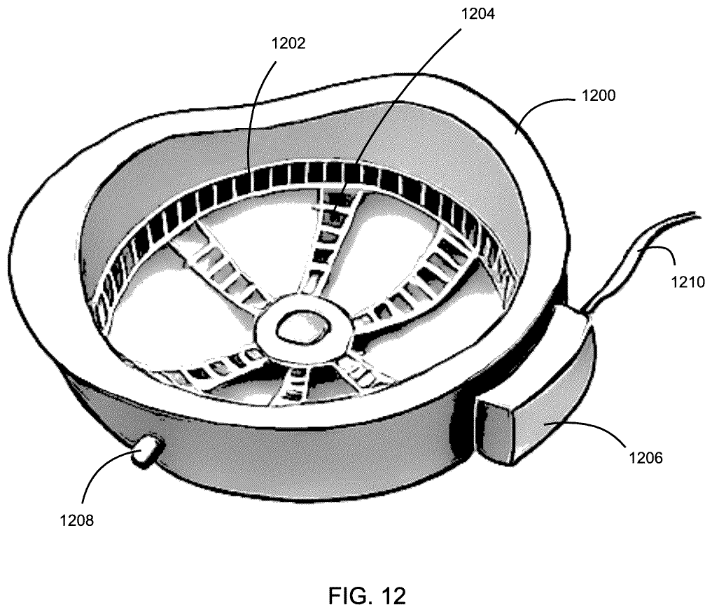

FIG. 12 illustrates the internal structure of the Haptic or Force Feedback System integrated into a helmet or headband, demonstrating the actuators used for application of pressure to simulate motion. The helmet internal structure 1200 is designed to house various components that facilitate the delivery of tactile feedback to the user. This structure provides the necessary support and housing for the pressure points 1202 and haptic actuators 1204, which are strategically positioned to simulate turning motions and predict motion directions, respectively. These components work in tandem to create a realistic sensation of movement, thereby aiding in the reconciliation of sensory inputs from the vestibular and proprioceptive systems.

The pressure points 1202 are designed to simulate turning motions by applying controlled pressure to the user's head. This is achieved through a series of actuators that can be adjusted to vary the intensity and duration of the pressure applied. The purpose of these pressure points is to mimic the sensation of turning, which is often a trigger for motion sickness. By providing a tactile cue that aligns with the expected motion, the system helps the brain to better process and integrate sensory information, reducing the likelihood of motion sickness.

Haptic actuators 1204 are integral to the system as they provide predictive feedback on motion directions. These actuators are capable of delivering subtle vibrations or pressure changes that signal upcoming movements, such as turns or accelerations. By doing so, they prepare the user for the motion, allowing the brain to anticipate and adjust to the changes more effectively. This predictive capability is enhanced by the integration of motion detection sensors 1208, which gather real-time data on environmental changes and vehicle dynamics.

The haptic feedback computing device 1206 is the central processing unit of the system, responsible for interpreting data from the motion detection sensors 1208 and controlling the haptic actuators 1204. This device processes inputs from various sensors, including gyroscopes, GPS receivers, cameras, radar, and LIDAR, to generate precise and timely tactile feedback. The computing device ensures that the feedback is synchronized with the actual motion of the vehicle, providing a seamless experience for the user. Alternatively, the computation could be offloaded to the vehicle's computation system, allowing for more complex data processing and reducing the load on the local device. This approach can enhance performance by leveraging powerful remote computing resources, though it may introduce latency issues that need to be managed to maintain real-time feedback.

Motion detection sensors 1208 continuously monitors the environment and detecting changes in motion. These sensors provide the necessary data for the haptic feedback computing device 1206 to generate accurate tactile signals. By using a combination of different sensor types, the system can capture a comprehensive picture of the vehicle's movements, allowing for more precise and effective feedback.

The electrical cable for external power 1210 ensures that the system remains operational by providing a reliable power source. This cable connects the helmet to an external power supply, which is essential for maintaining the functionality of the haptic actuators 1204 and the haptic feedback computing device 1206. The use of an external power source allows for continuous operation, making the system suitable for prolonged use in various environments. As a backup power option, the system is equipped with an internal battery that can take over in case of external power failure. This ensures uninterrupted functionality and enhances the system's reliability during critical operations.

The integration of artificial intelligence (AI) into the system further enhances its capabilities. AI algorithms are used to predict vehicle movements and pre-plan movement guidance, providing early alerts to users. This predictive functionality is particularly beneficial in reducing sensory mismatches, as it allows users to anticipate changes in motion and adjust their sensory expectations accordingly. The AI component can learn from past experiences and improve its predictions over time, making the system more effective in mitigating motion sickness.

The internal structural view of the haptic actuators integrated with the helmet offers a detailed solution to mitigating motion sickness through tactile feedback and active participation, without relying on visual input. By synchronizing the body's sensory inputs, the system effectively addresses the sensory conflicts that lead to motion sickness. This solution is particularly advantageous for individuals with visual impairments or those seeking alternatives to traditional visual-based remedies, providing a more comfortable and effective way to manage motion sickness symptoms in various environments.

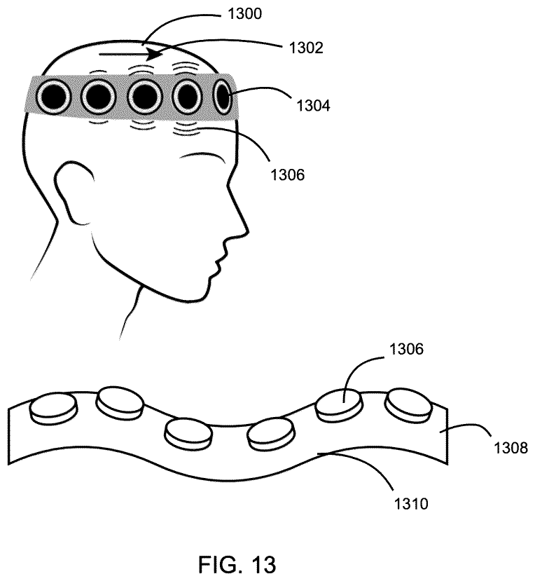

FIG. 13 illustrates a haptic or force feedback system integrated into a wearable headband, designed to mitigate motion sickness by providing tactile feedback to the user. The haptic system 1300 is embedded within the headband, which is worn around the user's head. This system is engineered to generate pressures in a specific order, simulating the sensation of movement and helping to reconcile sensory inputs from the vestibular and proprioceptive systems. The movement direction 1302 is indicated by the system, guiding the user's perception of motion and thereby reducing the sensory mismatch that often leads to motion sickness.

The headband features multiple actuators, one of which is labeled as actuator 1304. These actuators are strategically placed within the band to apply pressure or vibrations in a sequence that mimics real-world motion. The actuators motion icon 1306 demonstrates how haptic feedback signals are delivered, which simulate the sensation of movement. The actuators are designed to be responsive and precise, ensuring that the feedback provided is both timely and accurate, thereby enhancing the effectiveness of the system in reducing motion sickness. Additionally, the headband can be customized to adjust the intensity and pattern of the feedback, allowing users to tailor the experience to their personal comfort levels. This adaptability makes the device suitable for a wide range of applications, from virtual reality experiences to long-duration travel.

A close-up view of the flexible band, labeled as 1308, reveals the integration of multiple actuators embedded within the band. This design allows for a comprehensive distribution of tactile feedback across the head, providing a more immersive and effective experience. The flexibility of the band ensures that it can comfortably fit a variety of head sizes and shapes, maintaining consistent contact with the skin to deliver the tactile signals effectively. Additionally, the actuators are strategically positioned to target pressure points, enhancing the overall sensory experience. The band's lightweight and ergonomic design further contribute to user comfort, making it suitable for extended use without causing fatigue or discomfort.

The wavy shape of the band, indicated by label 1310, suggests that the band is both flexible and adjustable, enhancing comfort for the user. This design feature is for prolonged use, as it prevents discomfort and ensures that the tactile feedback remains effective over time. The adjustability of the band allows users to customize the fit to their preference, further improving the user experience. The headband can be used independently or integrated into other wearables, such as hat or virtual reality headsets. This versatility makes it suitable for a wide range of applications, from gaming to professional environments, where comfort and adaptability are crucial. Additionally, the material used in the band is lightweight and durable, ensuring long-lasting performance without compromising on comfort.

Potential applications can range from use in transportation to virtual reality and gaming, as well as healthcare and rehabilitation. In transportation, the system can be integrated into vehicles such as cars, airplanes, and boats to enhance passenger comfort, particularly for those who are visually impaired. In virtual reality and gaming, the system can be implemented in VR headsets and gaming chairs to reduce motion sickness during immersive experiences. In healthcare, the system can be used in therapeutic settings to assist patients with balance disorders or vestibular dysfunctions.

By synchronizing the body's sensory inputs, the system effectively addresses the sensory conflicts that lead to motion sickness. This solution is particularly beneficial for individuals with visual impairments or anyone seeking an alternative to traditional visual-based remedies, offering a more comfortable and effective way to manage motion sickness symptoms in various environments.

Piezoelectric is a material that generates an electric charge in response to mechanical stress. The mechanism of piezoelectricity involves the alignment of electric dipoles within the material. When mechanical stress is applied, the structure deforms, causing a shift in the dipoles and generating an electric charge across the material. Piezoelectric actuators are specific actuators using piezoelectric materials as active material and have a specific design to overcome traditional limitations of classical direct piezoelectric actuators. It is commonly used in sensors, actuators, and energy harvesting applications. These materials are also utilized in medical ultrasound equipment, quartz watches, and electronic musical instruments. Additionally piezoelectric materials are employed in precision motion control systems, automotive sensors, and vibration dampening technologies.

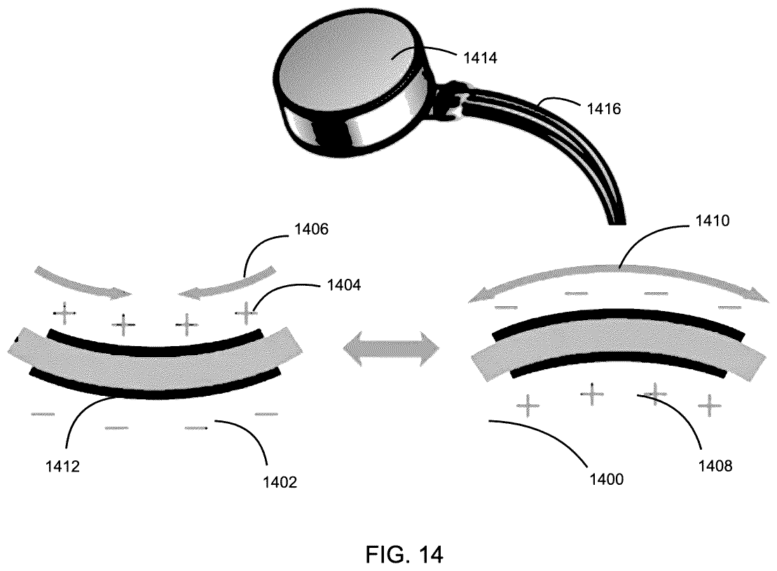

FIG. 14 illustrates a piezoelectric haptic actuator, which can be used in the tactile feedback system designed to mitigate motion sickness. The diagram 1400 demonstrates the operational mechanism of the piezoelectric haptic actuator, which includes metal plates 1412 and a metal case 1414. The actuator operates by applying positive or negative electrical charges, which cause it to bend in opposite directions, thereby generating pressure. This bending action is for delivering tactile feedback that simulates motion, aiding in the reconciliation of sensory inputs from the vestibular and proprioceptive systems.

The piezoelectric haptic actuator's functionality is based on the application of electrical charges. When a positive electrical charge 1404 is applied, the actuator contracts 1406, while a negative electrical charge 1402 causes the actuator to expand 1410. This reversible bending mechanism, triggered by reversed electrical charges 1408, allows the actuator to produce precise tactile signals. These signals are essential for simulating motion, which helps the brain align sensory inputs, thus reducing the likelihood of motion sickness. The metal plates 1412 is a component in the piezoelectric that collects electrical energy and converts it into mechanical energy.

Electrostatic actuators use electric fields to create forces that can simulate textures and friction on a surface, allowing users to feel different sensations when interacting with touchscreens or other interfaces. This type of actuator is particularly useful for creating dynamic and localized haptic feedback in compact devices. Other than the piezoelectric haptic actuator, other types of haptic actuator include the Linear Resonant Actuators (LRA) and eccentric rotating mass (ERM) motor. ERM motors create vibrations by rotating an off-center weight, providing tactile feedback. The Linear Resonant Actuator (LRA) uses a magnetic mass attached to a spring to create vibrations, offering precise and consistent tactile feedback. Additionally, there are electroactive polymers (EAPs), which change shape in response to electrical stimulation, providing flexible and adaptable haptic feedback. Another type of haptic actuator is the ultrasonic haptic actuator, which uses high-frequency sound waves to create a sense of touch by modulating air pressure. These actuators can provide a wide range of tactile sensations without direct contact.

A Linear Resonant Actuators (LRA) is illustrated in FIG. 14. These actuators use a magnetic mass attached to a spring, which vibrates linearly when an alternating current is applied, providing tactile feedback. They are commonly used in devices like smartphones and gaming controllers due to their efficient power consumption and precise control over vibration intensity and frequency. The metal case 1414 of the actuator are designed to withstand repeated bending and expansion, ensuring durability and reliability. The electrical wire 1416 connects the actuator to the control system, allowing for the precise application of electrical charges. This setup is integral to the system's ability to generate accurate tactile feedback, for its effectiveness in mitigating motion sickness. Linear Resonant Actuators (LRAs) are particularly effective in mitigating motion sickness due to their ability to provide consistent and controlled vibrations. To combat motion sickness, various types of haptic actuators can be employed. The adoption of which type depends on the specific requirements of the application, such as the desired intensity and frequency of vibrations, the size constraints of the device, and the power consumption limits. For instance, in portable devices where space and battery life are critical, piezoelectric actuators are often preferred due to their compact size and energy efficiency. Additionally, the choice of actuator may also be influenced by the user's sensitivity to different types of vibrations, as well as the overall design and functionality of the device.

Not illustrated explicitly in figures, the system employs a range of sensors, including gyroscopes, GPS receivers, cameras, radar, and LIDAR, to gather data on environmental changes. This data is processed to generate precise tactile feedback, enhancing the system's effectiveness in reducing motion sickness. The integration of artificial intelligence further improves the system's capabilities by predicting vehicle movements and providing early alerts to users, thereby reducing sensory mismatches. Additionally, the AI continuously learns from user interactions, adapting its responses to improve comfort and accuracy over time. This dynamic approach ensures that the system remains responsive to varying conditions and user preferences, ultimately enhancing the overall user experience.

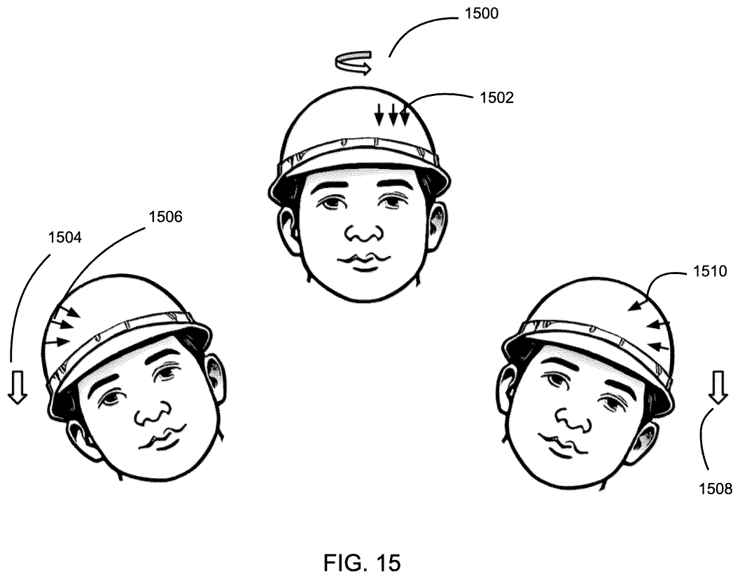

FIG. 15 illustrates a helmet designed to generate pressure to assist users in anticipating vehicle movements in various directions. This innovative helmet is part of a tactile feedback system aimed at reducing motion sickness by providing non-visual cues to the user. The helmet is equipped with mechanisms to apply rotational pressure, which simulates the sensation of movement, thereby aiding the brain in reconciling sensory inputs from the vestibular and proprioceptive systems. The helmet's design is particularly beneficial for individuals who are visually impaired or in situations where visual input is unavailable, or limited. Some users may prefer to rest their eyes during travel, making this tactile feedback system an ideal solution. Additionally, the helmet can be customized to adjust the intensity and pattern of pressure, catering to individual preferences and sensitivities. This adaptability ensures that users can experience a comfortable and effective reduction in motion sickness symptoms, enhancing their overall travel experience.

The helmet's functionality is centered around its ability to simulate rotational movements, as depicted by label 1500, which indicates the rotation movement. This is achieved through the application of rotational pressure, as shown by label 1502, which is applied in the direction of movement. The speed and intensity of this pressure are adjusted based on the calculated movement direction and velocity, ensuring that the tactile feedback is both accurate and timely. This feature is integral to the system's effectiveness in reducing motion sickness, as it helps the user anticipate and adapt to changes in movement.

Direction label 1504 illustrates the helmet's capability to simulate shifting or inclining to the right. This is accomplished by applying rotational pressure to the right side of the head, as indicated by label 1506. This targeted pressure application helps the user perceive the sensation of turning or leaning, which is often a source of sensory conflict leading to motion sickness. By providing this tactile cue, the helmet aids in aligning the user's sensory inputs, thereby mitigating the effects of motion sickness.

Label 1508 demonstrates the helmet's ability to simulate shifting or inclining to the left. The corresponding rotational pressure is applied to the left side of the head, as shown by label 1510. This balanced approach ensures that the user receives consistent and coherent tactile feedback, regardless of the direction of movement. The ability to simulate both right and left inclinations is for providing a comprehensive solution to motion sickness, as it addresses the full range of potential sensory conflicts.

The integration of artificial intelligence (AI) enhances the helmet's capabilities. AI algorithms are employed to predict vehicle movements and pre-plan movement guidance, providing early alerts to users. This proactive approach allows users to anticipate changes in movement, reducing the likelihood of sensory mismatches that can lead to motion sickness. The Al's ability to process data from various sensors, such as gyroscopes and GPS receivers, ensures that the tactile feedback is both precise and adaptive to real-time environmental changes. Those components are implied to work seamlessly together, creating a more intuitive and responsive user experience. By continuously learning from user interactions and environmental conditions, the AI system can refine its predictions and improve its guidance over time. This integration not only enhances safety but also contributes to a more comfortable and enjoyable journey for the passenger.

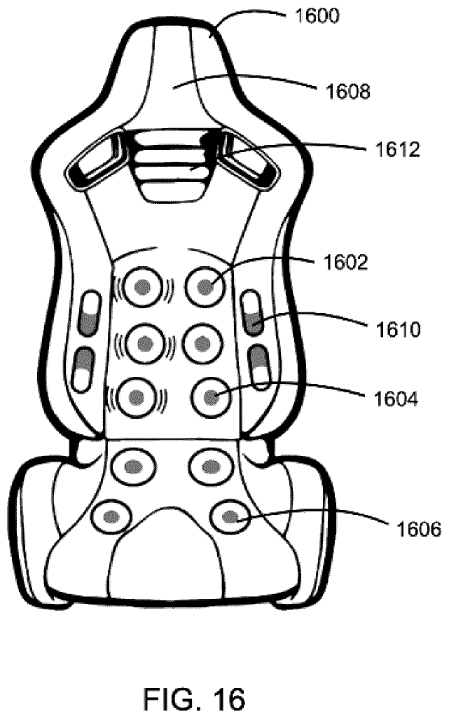

FIG. 16 illustrates an ergonomically designed seat with integrated haptic actuators, providing tactile feedback through pressure to predict turns, accelerations, or decelerations. The overall framework of the seat, labeled as 1600, serves as the structural foundation housing the haptic actuators and support elements. This framework ensures the stability and durability of the seat while accommodating the various haptic components that deliver the tactile feedback essential for mitigating motion sickness. The seat's design prioritizes user comfort and safety, with strategically placed actuators 1602, 1604, 1610 that respond to vehicle dynamics. These actuators are controlled by a central processing unit 1608, which interprets data from sensors 1612 to adjust feedback in real-time, enhancing the user's awareness of motion changes. Additionally, the seat's materials are chosen for their durability and comfort, ensuring a pleasant experience during extended use.

The Upper Back Haptic Actuators, labeled as 1602, are positioned to provide cues related to forward acceleration or braking. These actuators are designed to apply pressure or vibrations to the upper back area of the user, simulating the forces experienced during acceleration or deceleration. By doing so, they help the brain reconcile the sensory inputs from the vestibular and proprioceptive systems, thereby reducing the likelihood of motion sickness. This feature is particularly beneficial in vehicles where sudden changes in speed are common. Additionally, these actuators can enhance the user's awareness of vehicle dynamics, improving overall comfort and safety.

Lower Back Haptic Actuators, labeled as 1604, are responsible for providing lateral feedback, which simulate the sensation of turning or maintaining stability during motion. These actuators apply pressure or vibrations to the lower back, mimicking the forces experienced during turns. This tactile feedback helps users anticipate and adjust to changes in direction, further aiding in the synchronization of sensory inputs and reducing sensory mismatches that can lead to motion sickness. These actuators can enhance the immersive experience in virtual reality environments by providing realistic physical cues. By delivering precise feedback, they can improve user engagement and can be particularly beneficial in training simulations, gaming, and rehabilitation therapies.

The Seat Cushion Haptic Actuators, labeled as 1606, are designed to provide vibration or pressure-based feedback to the user. These actuators are integrated into the seat cushion and are particularly effective in simulating road textures or vibrations experienced during travel. By delivering these subtle cues, the seat cushion actuators enhance the overall tactile feedback system, contributing to a more immersive and comfortable experience for the user. They can be customized to suit individual preferences, allowing users to adjust the intensity and pattern of feedback for optimal comfort and engagement.

Haptic computing devices, labeled as 1608, processes the data collected from various sensors and generating the appropriate tactile feedback signals. These devices utilize algorithms to interpret sensor data, such as vehicle speed, direction, and environmental conditions, to produce real-time feedback that aligns with the user's motion experience. Additionally, the computation unit 1608 also uses AI to enhance the accuracy and responsiveness of the feedback by learning from user interactions and adapting to different scenarios. This integration of AI allows the device to provide more personalized and intuitive tactile experiences, improving user engagement and satisfaction. The integration of haptic computing devices ensures that the tactile feedback is both accurate and responsive, further enhancing the effectiveness of the system in mitigating motion sickness.

Additional actuators installed on the sides, labeled as 1610, provide supplementary tactile feedback to enhance the user's experience. These side actuators can simulate lateral forces experienced during sharp turns or sudden maneuvers, offering a more comprehensive tactile feedback system. By incorporating these additional actuators, the system can deliver a more nuanced and realistic simulation of motion, which is for effectively addressing the sensory conflicts that lead to motion sickness.

The disclosure's tactile feedback system, as demonstrated in FIG. 16, offers a versatile solution that can be integrated into various transportation modes, including cars, airplanes, and boats. Its application extends beyond transportation, finding utility in virtual reality and gaming environments where motion simulation is essential. The system's ability to function independently of visual input makes it particularly advantageous for individuals with visual impairments or those in environments where visual cues are limited. In additional to the solution illustrated in FIG. 16, which embeds the haptic actuators into the seat, another configuration involves integrating the actuators directly into removable seat cover, allowing for easy customization and maintenance. This design offers flexibility for users who may want to switch between different tactile feedback patterns or upgrade the system without replacing the entire seat. Furthermore, the removable seat cover can be adapted to fit various seat models, making it a cost-effective option for retrofitting existing vehicles or equipment.

The modular design of the system facilitates easy adaptation and scalability, making it suitable for both personal and commercial use. The system's modular design allows for seamless updates and enhancements, ensuring compatibility with future technological advancements. This adaptability not only extends the lifespan of the product but also provides users with the opportunity to personalize their experience according to their specific needs and preferences. The integration of wireless connectivity further enhances the system's functionality, enabling remote control and real-time adjustments through a smartphone app or other smart devices.

This feature is particularly beneficial in dynamic environments where quick changes to feedback settings are necessary. Overall, the tactile feedback system represents a significant advancement in user interaction technology, offering a blend of comfort, accessibility, and innovation.

One of the advantages of this disclosure is its reliance on tactile feedback rather than visual cues, making it accessible to a broader range of users, including those who are visually impaired. By focusing on the vestibular and proprioceptive systems, the disclosure provides a more inclusive approach to managing motion sickness, offering a solution that is both innovative and effective.

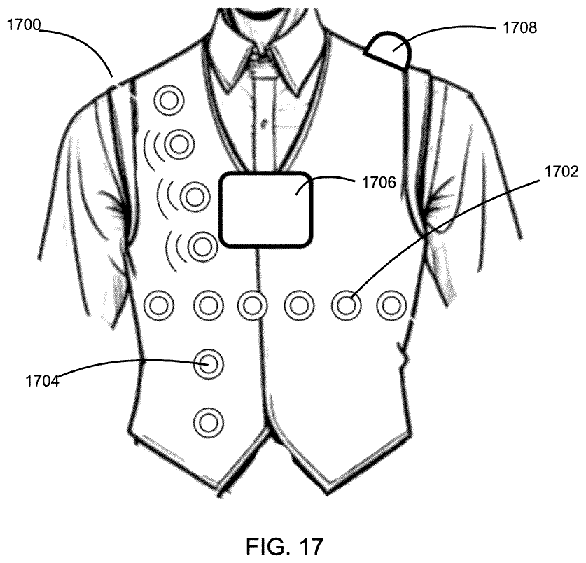

FIG. 17 illustrates a vest integrated with pressure-generating actuators designed to provide tactile feedback to the human body, allowing users to anticipate vehicle movements. The vest structure 1700 is a wearable component that forms the basis of the tactile feedback system. This vest is designed to be worn by users, ensuring that the tactile feedback is delivered effectively without causing discomfort. The vest is equipped with a series of actuators that are strategically placed to simulate various types of motion, thereby assisting in reconciling sensory inputs from the vestibular and proprioceptive systems. The vest can be customized to individual preferences and body shapes, ensuring optimal comfort and effectiveness, or it can design to fit users within a standard size range. The actuators are controlled by a central processing unit that interprets vehicle dynamics data and translates it into corresponding tactile signals.

The horizontal actuators 1702 are specifically configured to simulate lateral motion or directional changes. These actuators apply pressure or vibrations to the sides of the body, mimicking the sensation of turning or swerving. This feature is particularly beneficial in environments where visual cues are limited or unavailable, such as in autonomous vehicles or for visually impaired individuals. By providing a tactile representation of lateral movements, the vest helps users anticipate and adapt to changes in direction, thereby reducing the likelihood of motion sickness.

Vertical actuators 1704 are designed to deliver tactile cues for movement or acceleration changes. These actuators are positioned to simulate the sensation of moving up or down, such as when a vehicle accelerates or decelerates. The vertical actuators can mimic the feeling of road bumps or changes in elevation, providing users with a more comprehensive understanding of their movement through space. This tactile feedback is for maintaining balance and orientation, especially in situations where visual input is compromised.

The processing and power unit 1706 is responsible for controlling the feedback intensity and patterns. This unit processes data from various sensors, such as gyroscopes and GPS receivers from the vehicle, to determine the appropriate tactile response. The processing unit ensures that the feedback is synchronized with the actual movement of the vehicle, providing real-time adjustments to the tactile signals. This synchronization is for effectively reducing sensory mismatches that lead to motion sickness. The power is provided by plugin the vest into vehicle's power system, and dedicated battery system that ensures consistent performance and reliability. This battery system is designed to handle the energy demands of the processing unit and maintain uninterrupted operation during vehicle use. For example, when user is temporarily disconnected from the vehicle's power system, the battery seamlessly takes over to ensure continuous functionality. This dual power setup not only enhances user experience but also provides a fail-safe mechanism, ensuring that the tactile feedback remains operational under various conditions. Additionally, the battery system is equipped with efficient charging capabilities, allowing it to recharge quickly when reconnected to the vehicle's power source.

The shoulder component 1708 contains sensors and communication devices that enhance the functionality of the vest. These sensors gather data on the user's movements and the surrounding environment, which is then used to refine the tactile feedback. The communication devices enable the vest to interact with other systems, such as a vehicle's onboard sensors or external data sources. This connectivity allows for a more integrated approach to motion sickness mitigation, as the vest can adapt its feedback based on real-time environmental changes.

For customized vest, the motion signals can be collected from a specific vehicle that support the standardized communication protocols, allowing the vest to adapt its feedback based on the unique characteristics of that vehicle. Once onboarding the vehicle, user can login the vest to integrate with vehicle through wireless connectivity, enabling real-time updates feed into the feedback system. This feature enhances the user experience by providing seamless interaction with the vehicle's systems, ultimately improving safety, system performance, precision, and comfort during travel.

The tactile feedback system according to various embodiments of the present disclosure can offer several advantages over traditional motion sickness remedies. By focusing on tactile stimuli rather than visual cues, the system provides a solution that is accessible to a broader range of users, including those with visual impairments. The integration of artificial intelligence further enhances the system's effectiveness by predicting vehicle movements and generating early alerts. For user's feeling not comfortable wearing the haptic feedback system overhead, the vest can be adjusted to provide feedback through other areas of the body, such as the torso or arms. This flexibility ensures that users can still benefit from the system's features without compromising comfort. In practical applications, the vest can be used in various transportation settings, such as cars, airplanes, and boats, to enhance passenger comfort. It can also be integrated into virtual reality and gaming environments to reduce motion sickness during immersive experiences. In healthcare and rehabilitation, the vest can assist patients with balance disorders or vestibular dysfunctions by providing consistent tactile feedback that aids in sensory reconciliation.

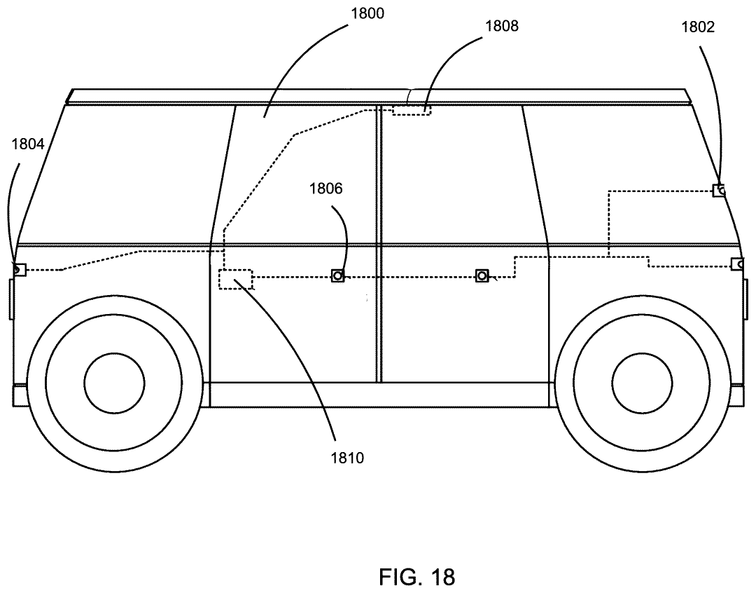

FIG. 18 illustrates a side view schematic diagram of a system designed to prevent motion sickness in vehicles, according to some examples of the present disclosure. The system is composed of several components, each playing a role in the detection and mitigation of motion sickness. The vehicle 1800 serves as the platform for the system, integrating various sensors and processing units to deliver effective tactile feedback.

The front view camera 1802 and rear-view camera 1804 are integral to the system's ability to gather visual data from the vehicle's surroundings. These cameras capture real-time images and video, which are then analyzed to detect changes in the vehicle's environment. This visual data is used by the processing unit 1810, which calculates movement and generates signals for pressure feedback. By understanding the vehicle's movement through its environment, the system can more accurately simulate or predict motion, thereby aiding in the reconciliation of sensory inputs from the vestibular and proprioceptive systems.

The lateral motion sensor 1806 and rotational motion sensor 1808 can detect the vehicle's movements in different axes. The lateral motion sensor 1806 detects side-to-side movements, while the rotational motion sensor 1808 captures rotational movements such as turning or spinning. These sensors can provide data that allows the system to understand the vehicle's dynamics and generate appropriate tactile feedback. This feedback is delivered through wearable devices or environmental components, such as seats or vests, that are integrated with the tactile feedback system.

The processing unit 1810 is the brain of the system, responsible for calculating movement and generating signals for pressure feedback. It processes data from the cameras and motion sensors to determine the vehicle's current state and predict future movements. This predictive capability is enhanced by artificial intelligence algorithms, which allow the system to pre-plan movement guidance and provide early alerts to users. By anticipating changes in motion, the system can deliver timely tactile feedback that helps users adjust their sensory perceptions, reducing the likelihood of motion sickness.

The disclosure also provides an interactive device for active participation. This device is inspired by the observation that active involvement in vehicle operation, such as driving, reduces motion sickness. The interactive device allows users to engage in simulated driving experiences, thereby involving the brain in anticipating movement and reducing sensory mismatches. Users can perform driving-like movements following hints displayed on the device screen, synchronizing their actions with the vehicle's motion. The interactive device also offers customization options, allowing users to select their preferred degree of control over the simulated driving experience. This feature ensures that the device can be tailored to individual preferences and needs, enhancing its effectiveness in reducing motion sickness. By providing feedback and measuring user movements, the device ensures synchronization with the vehicle, further aiding in the reconciliation of sensory inputs.

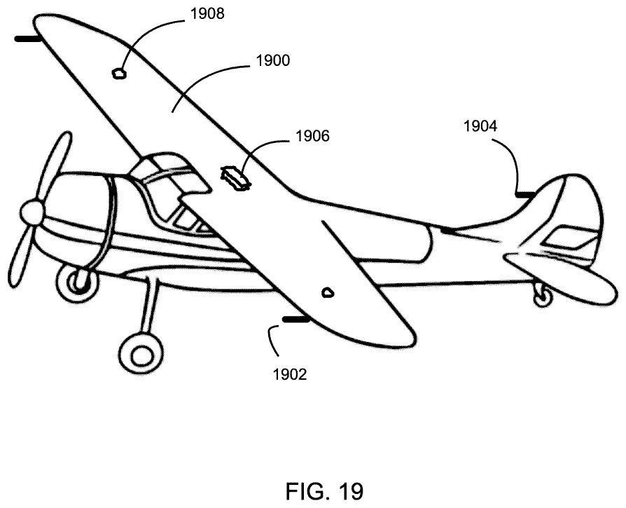

FIG. 19 illustrates a perspective view of a system designed to prevent motion sickness in aircraft, according to some examples of the present disclosure. The system is integrated into the aircraft 1900 and utilizes a combination of sensors to gather data on the aircraft's movements. These sensors include a speed sensor 1902, an acceleration sensor 1904, a vertical motion sensor 1906, and a gyroscopic sensor 1908. Each of these components can help to detect and interpreting the aircraft's motion, which is used for generating the appropriate tactile feedback to mitigate motion sickness.

The speed sensor 1902 is responsible for measuring the velocity of the aircraft. This data helps for understanding the rate of movement and changes in speed, which can contribute to the onset of motion sickness. By accurately capturing speed variations, the system can adjust the tactile feedback to simulate a stable environment, thereby reducing the sensory mismatch that often leads to discomfort. The acceleration sensor 1904 detects changes in the aircraft's speed over time, providing data on the forces experienced by passengers. This sensor helps to identify rapid accelerations or decelerations that can exacerbate motion sickness. By processing this information, the system can deliver tactile signals that mimic a more gradual and predictable motion, helping passengers' vestibular systems to better align with the perceived motion.

The vertical motion sensor 1906 measures the aircraft's movements along the vertical axis, such as during takeoff, landing, or turbulence. Vertical motion can be particularly disorienting and is a common trigger for motion sickness. By detecting these movements, the system can generate tactile feedback that simulates a smoother vertical transition, thereby minimizing the impact on passengers' vestibular and proprioceptive systems. The gyroscopic sensor 1908 provides data on the aircraft's orientation and rotational movements, such as roll, pitch, and yaw. These movements can create a significant sensory conflict, especially when visual cues are limited or absent. The gyroscopic sensor helps the system to anticipate and counteract these rotational forces by delivering corresponding tactile feedback, which aids in maintaining a sense of equilibrium for the passengers.

The integration of these sensors into the aircraft's motion sickness prevention system allows for a comprehensive approach to mitigating discomfort. By continuously monitoring and analyzing the aircraft's movements, the system can provide real-time tactile feedback that aligns with the passengers' sensory inputs. This proactive approach not only reduces the likelihood of motion sickness but also enhances the overall comfort and experience of air travel. The disclosure's application extends beyond aircraft, offering potential benefits in various transportation modes, including cars, boats, and trains. In each case, the system can be adapted to the specific motion characteristics of the vehicle, ensuring that passengers receive the most effective tactile feedback for their environment.

In addition to the tactile feedback system, the disclosure includes an interactive device for active participation. This device allows users to engage in simulated driving experiences, reducing motion sickness by involving the brain in anticipating movement. The device collects movement data through various sensors and uses machine learning algorithms to predict vehicle movements. Users can perform driving-like movements following hints displayed on the device screen, synchronizing their actions with the vehicle's motion.

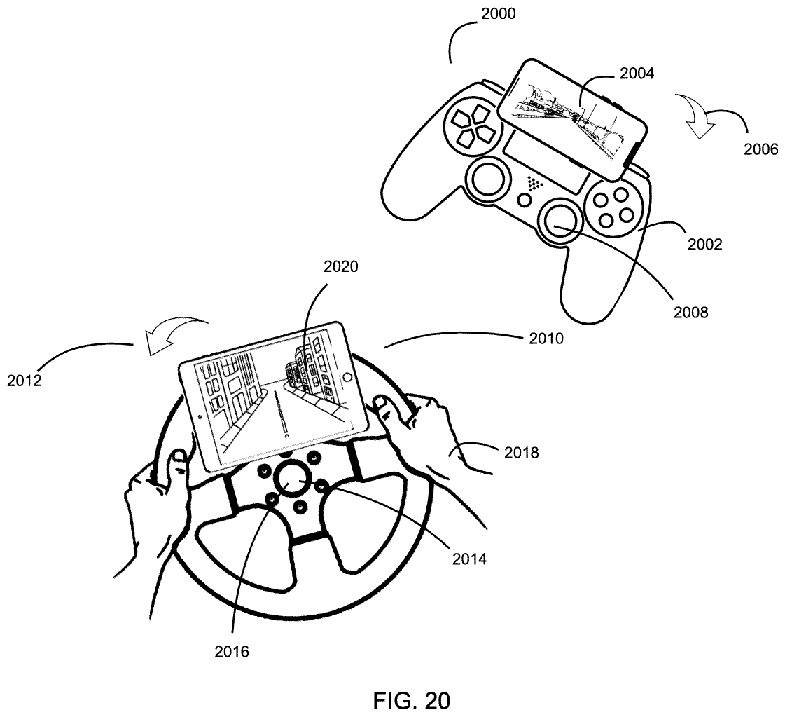

FIG. 20 illustrates an interactive game controller or a gaming steering wheel, both integrated with embedded screens or, integrated with a tablet or smartphone, designed to display a simulated driving or flight interface. This system is engineered to assist users in predicting vehicle or aircraft movements, allowing them to imitate control actions to reduce motion sickness. The game controller with an embedded screen 2000 serves as a central component, providing users with a visual interface that mimics real-world driving scenarios. The game controller 2002 is ergonomically designed to facilitate ease of use, while the smartphone 2004 attached to the controller acts as a dynamic display, offering real-time feedback and visual cues.

The right tilting feature 2006 of the game controller indicates vehicle movement, enabling users to anticipate and mimic driving actions by turning the controller. This feature provides a sense of control, which can reduce sensory mismatches that often lead to motion sickness. The wireless unit 1008 integrated into the controller receives motion data from the vehicle, ensuring that the feedback provided to the user is accurate and timely. This real-time data transmission is essential for maintaining synchronization between the user's actions and the vehicle's movements.

The steering wheel 2010, equipped with a tablet mounted in the center, offers an immersive experience for users who prefer traditional driving interfaces. The left tilting feature 2012 shows user turning the wheel to left, simulating control over the vehicle's direction. This interaction not only engages the user's brain in anticipating movement but also provides a tactile response that aids in reconciling sensory inputs from the vestibular and proprioceptive systems. The wireless unit on the wheel 2014 ensures seamless communication with the vehicle, providing users with up-to-date information on vehicle dynamics.

User can turn on or off the optional rotational vibration or torque generation unit 2016, which offers an additional layer of feedback. This unit can simulate the sensation of turning or acceleration, providing non-visual cues that help users anticipate and adapt to vehicle movements. The hand placement 2018 demonstrates how users can grip the wheel for an immersive interaction, ensuring that the tactile feedback is effectively transmitted to the user. This feature is designed to enhance the driving experience by providing intuitive feedback, making it easier for users to respond to changes in the vehicle's dynamics. This feature is for visual impaired users as it provides non-visual cues that enhance their ability to perceive and react to the vehicle's movements. By offering rotation and motion feedback, the system ensures that visually impaired drivers can maintain better control and awareness.

The simulated roadway view 2020 displayed on the embedded screens provides users with a realistic driving experience, enhancing the overall effectiveness of the system in reducing motion sickness. By offering a visual representation of the road ahead, users can better anticipate changes in vehicle dynamics, aligning their sensory inputs with the actual motion of the vehicle. For vision impaired users, the system's motion or rotation feedback provides an alternative means of perceiving changes in the vehicle's movement, helping them to understand how is their movement align with the vehicles' orientation and balance.

The user interface is configured to allow active participation, which can reduce sensory mismatches. By involving the brain in anticipating movement, the device helps users align their sensory perceptions with the actual motion of the vehicle, thereby mitigating the symptoms of motion sickness. The software component of the motion reduction system can be implemented as a rewarding system, encouraging users to follow the motion prediction closely. This approach not only enhances user experience but also reinforces positive interactions by providing feedback or incentives when users successfully anticipate movements, and active engagement fosters a sense of control and confidence. By integrating gamification elements, such as points or achievements, the system motivates users for active engagement, leading to a more enjoyable and comfortable journey.

The integration of sensors to collect movement data and algorithms to predict vehicle movements, can enhance the device's ability to provide accurate feedback. Users can perform driving-like movements following hints displayed on the device screen, synchronizing their actions with the vehicle's motion. This synchronization helps to reduce the sensory conflicts that often lead to motion sickness. The integration can be through the wireless or Bluetooth connection of user's smartphone or iPad, or integrated as part of the game controller.

Additional software system may need to be developed to support the integration and ensure seamless communication between the sensors and the device. This software should be capable of processing real-time data, using AI to compute and predict vehicle trajectories and adjust feedback accordingly. By leveraging machine learning algorithms, the system can continuously improve its predictions based on user behavior and environmental conditions. This software should also in charge of adjusting feedback mechanisms, and providing updates to enhance user experience. Furthermore, it should be compatible with various platforms and devices to maximize accessibility and usability.

Users can customize interaction levels by selecting their preferred degree of control over the simulated driving experience. This customization allows users to tailor the experience to their comfort level, ensuring that the device effectively meets their individual needs in reducing motion sickness. Additionally, users can adjust settings such as speed sensitivity, visual feedback, and audio cues to further enhance their comfort and enjoyment.

FIG. 11 illustrates a user seated in an airplane, holding an aircraft driving simulation unit to simulate the experience of controlling the aircraft. This setup is part of an approach to reducing motion sickness through active participation. The user, labeled as 1100, is engaged with a flight simulation system that allows them to experience aircraft control, thereby actively participating in the motion experience. This active engagement can help the brain anticipate movements, reducing the sensory mismatch that often leads to motion sickness.

The Aircraft Simulation Controller, labeled as 2102, is a handheld device equipped with a screen and controls. This device is central to the interactive experience, providing users with visual and tactile feedback that mimics the control of an actual aircraft. By allowing users to perform driving-like movements in response to hints displayed on the device screen, the controller helps synchronize the user's actions with the vehicle's motion, thereby reducing sensory mismatches. This method is particularly effective as it engages the user's brain in anticipating movement, a factor in mitigating motion sickness. The airplane window, labeled as 2104, shows the simulation environment is for an airplane passenger. While the presence of the window can provide additional visual cues that help the user reconcile the simulated motion with the actual motion of the airplane, the real-life visual cure is not always available due to factors like weather conditions or flight path. The simulation controller can facilitate achieving various functions according to some embodiments of this disclosure.

The Game Controller with Embedded Screen, labeled as 2106, is a close-up view of user operating the device, showcasing the interactive display and intuitive controls. This controller can provide simulated visual cure that predict the flight movement, acceleration, and trajectory of virtual objects. It provides immediate feedback and control options, allowing the user to adjust their actions in real-time. The embedded screen displays the simulated flight, labeled as 2108, offering a visual representation of the aircraft's movements. This visual feedback can help users anticipate changes in motion.

Wireless communication on the airplane, labeled as 2110, ensures that the simulation system can receive and process data in real-time. This communication capability allows the system to adjust the simulation based on the airplane's actual movements, providing a more accurate and immersive experience for the user. The wireless can transform the signals collected from the airplane to the smartphone or game controller, labeled as 2112, facilitates seamless integration of personal devices, allowing users to customize their experience and control the simulation according to their preferences.

The method for reducing motion sickness through active participation, as described in the claims, involves allowing a user to perform driving-like movements in response to hints displayed on a device screen. This approach is particularly beneficial in environments where visual input is limited or unavailable, such as in airplanes or for visually impaired individuals. By engaging the user's brain in anticipating movement, the system effectively reduces sensory mismatches, providing a more comfortable and enjoyable experience. The advantages of this disclosure are manifold. It provides a non-invasive, drug-free method for reducing motion sickness, making it accessible to a wide range of users. By focusing on tactile feedback and active participation, it offers a highly customizable user experience, enhancing its appeal and effectiveness across various applications.

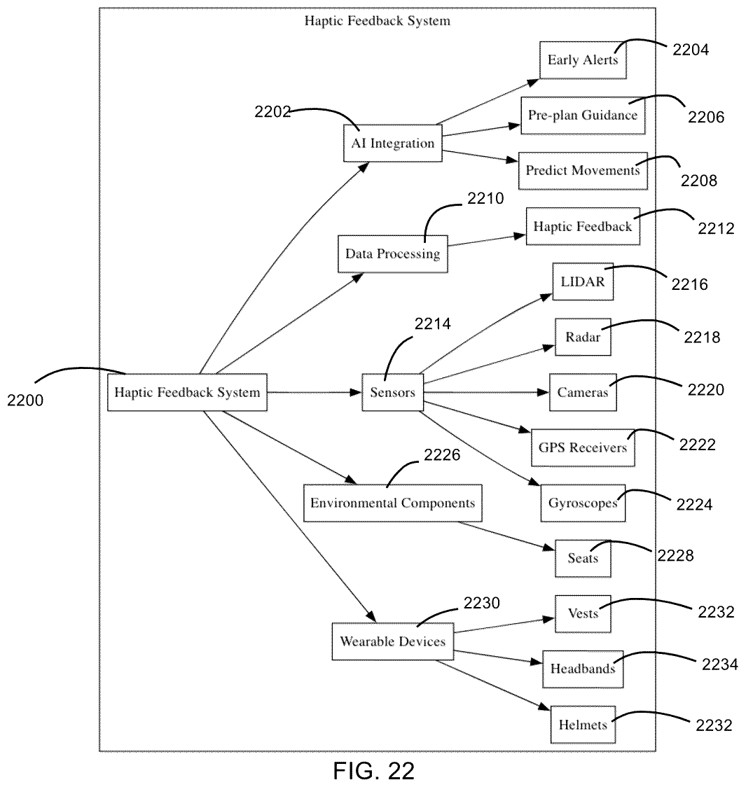

FIG. 22 illustrates the Haptic Feedback System represented as a structured block diagram, showcasing the integration and interaction of various components and subsystems to enable haptic feedback for diverse applications. The Haptic Feedback System 2200 is the central component that orchestrates the entire process of reducing motion sickness through tactile feedback. This system is designed to function independently of visual input.

The AI Integration module 2202 can enhance the system's capabilities by predicting vehicle movements and generating early alerts. This predictive capability is essential for pre-planning movement guidance, which helps users anticipate changes in motion, thereby reducing sensory mismatches that often lead to motion sickness. The AI algorithms analyze data from various sensors to forecast potential movements, ensuring that the tactile feedback is timely and accurate.

Early Alerts 2204 and Pre-plan Guidance 2206 are interconnected subsystems that work in tandem with the AI Integration module. These components are responsible for providing users with anticipatory cues about upcoming movements. By alerting users to changes in motion before they occur, the system helps align the sensory inputs from the vestibular and proprioceptive systems, mitigating the effects of motion sickness.

The Predict Movements module 2208 is integral to the system's functionality, as it processes data from multiple sensors to forecast vehicle dynamics. This module ensures that the tactile feedback is synchronized with the actual motion of the vehicle, providing users with a coherent sensory experience that reduces the likelihood of motion sickness.

Data Processing 2210 can handle the influx of data from various sensors. This module processes environmental data to generate precise tactile feedback signals. The processed data is then used to control the Haptic Feedback 2212 mechanisms, which deliver the tactile signals to the user through wearable devices or environmental components.

The Sensors 2214, including LIDAR 2216, Radar 2218, Cameras 2220, GPS Receivers 2222, and Gyroscopes 2224, form the backbone of the system's data acquisition process. These sensors gather comprehensive data about the vehicle's environment and movements, which can generate accurate tactile feedback. The integration of these sensors ensures that the system can adapt to various conditions and provide reliable feedback to users.

The wearable components 2226, such as Seats 2228, Vests 2230, and Wearable Devices 2232 like Headbands 2234 and Helmets 2236, are designed to deliver the tactile feedback to users. These components are equipped with mechanisms that apply pressure, vibrations, or other tactile signals to simulate motion. This simulation helps users reconcile sensory inputs, reducing the sensory conflicts that cause motion sickness.

It should be understood that each part of the present disclosure can be implemented by hardware, software, firmware, or a combination thereof. In the above embodiments, multiple steps or methods can be implemented by software or firmware stored in a memory and executed by a suitable instruction execution system. For example, if implemented in hardware, as in another embodiment, it can be implemented using any one or a combination of the following techniques known in the art: Discrete logic circuits, ASICs with suitable combinational logic gate circuits, programmable gate arrays (PGA), field programmable gate arrays (FPGA), etc.

It is apparent that those of ordinary skill in the art can make various modifications and variations to the embodiments of the disclosure without departing from the spirit and scope of the disclosure. Thus, it is intended that the present disclosure covers the modifications and variations.

Various embodiments in this specification have been described in a progressive manner, where descriptions of some embodiments focus on the differences from other embodiments, and same or similar parts among the different embodiments are sometimes described together in only one embodiment.

In addition, in the description of the present disclosure, the terms “center,” “longitudinal,” “lateral,” “length,” “width,” “thickness,” “upper,” “lower,” “front,” “rear,” “left,” “right,” “vertical,” “horizontal,” “top,” “bottom,” “inside,” “outside,” “clockwise,” “counterclockwise,” “axial,” “radial,” “circumferential,” etc. are based on the azimuth or position relationship shown in the drawings, and are only for the convenience of describing the present disclosure and simplifying the description. The orientation and construction and operation in a specific orientation cannot be understood as a limitation on the present disclosure.

In addition, the terms “first” and “second” are used for descriptive purposes only and cannot be understood as indicating or implying relative importance or implicitly indicating the number of technical features indicated. Therefore, the features defined as “first” and “second” can explicitly or implicitly include at least one of the features. In the description of the present disclosure, the meaning of “a plurality” is at least two, for example, two, three, etc., unless it is specifically and specifically defined otherwise.

Moreover, the terms “include,” “including,” or any other variations thereof are intended to cover a non-exclusive inclusion within a process, method, article, or apparatus that comprises a list of elements including not only those elements but also those that are not explicitly listed, or other elements that are inherent to such processes, methods, goods, or equipment.

In the case of no more limitation, the element defined by the sentence “includes a . . . ” does not exclude the existence of another identical element in the process, the method, or the device including the element.

Specific examples are used herein to describe the principles and implementations of some embodiments. The description is only used to help convey understanding of the possible methods and concepts. Meanwhile, those of ordinary skill in the art can change the specific manners of implementation and application thereof without departing from the spirit of the disclosure. The contents of this specification therefore should not be construed as limiting the disclosure.

In the descriptions, with respect to circuit(s), unit(s), device(s), component(s), etc., in some occurrences singular forms are used, and in some other occurrences plural forms are used in the descriptions of various embodiments. It should be noted; however, the single or plural forms are not limiting but rather are for illustrative purposes. Unless it is expressly stated that a single unit, device, or component etc. is employed, or it is expressly stated that a plurality of units, devices or components, etc. are employed, the circuit(s), unit(s), device(s), component(s), etc. can be singular, or plural.

Based on various embodiments of the present disclosure, the disclosed apparatuses, devices, and methods can be implemented in other manners. For example, the abovementioned devices can employ various methods of use or implementation as disclosed herein.

Dividing the device into different “regions,” “units,” or “layers,” etc. merely reflect various logical functions according to some embodiments, and actual implementations can have other divisions of “regions,” “units,” or “layers,” etc. realizing similar functions as described above, or without divisions. For example, multiple regions, units, or layers, etc. can be combined or can be integrated into another system. In addition, some features can be omitted, and some steps in the methods can be skipped.

Those of ordinary skill in the art will appreciate that the units, regions, or layers, etc. in the devices provided by various embodiments described above can be provided in the one or more devices described above. They can also be located in one or multiple devices that is (are) different from the example embodiments described above or illustrated in the accompanying drawings. For example, the units, regions, or layers, etc. in various embodiments described above can be integrated into one module or divided into several sub-modules.

The order of the various embodiments described above are only for the purpose of illustration, and do not represent preference of embodiments.

Although specific embodiments have been described above in detail, the description is merely for purposes of illustration. It should be appreciated, therefore, that many aspects described above are not intended as required or essential elements unless explicitly stated otherwise.

In the present disclosure, the terms “installation,” “connected,” “connected,” “fixed” and other terms shall be understood in a broad sense unless otherwise specified and limited, for example, they can be fixed connections or removable connections or integrated; it can be mechanical or electrical; it can be directly connected or indirectly connected through an intermediate medium; it can be the internal connection of two elements or the interaction between two elements, unless otherwise specified. For those of ordinary skill in the art, the specific meanings of the above terms in the present disclosure can be understood according to specific situations.

In the present disclosure, unless explicitly stated and defined otherwise, the first feature being “on” or “over” the second feature may be the first and second features in direct contact, or the first and second features indirectly contact through an intermediate medium. Moreover, the first feature being “above” the second feature may indicate that the first feature is directly above or obliquely above the second feature, or it only indicates that the first feature is higher in level than the second feature. The first feature being “below,” “under,” or “underneath” the second feature indicates that the first feature may be directly below or obliquely below the second feature, or it may simply indicate that the first feature is less horizontal than the second feature.

In the description of this specification, the description with reference to the terms “one embodiment,” “some embodiments,” “examples,” “specific examples,” or “some examples” and the like means specific features described in conjunction with the embodiments or examples. Structures, materials, or features are included in at least one embodiment or example of the disclosure. In this specification, the schematic expressions of the above terms are not necessarily directed to the same embodiment or example. Furthermore, the particular features, structures, materials, or characteristics described can be combined in any suitable manner in any one or more embodiments or examples. In addition, without any contradiction, those skilled in the art can combine and combine different embodiments or examples and features of the different embodiments or examples described in this specification.

Various modifications of, and equivalent acts corresponding to the disclosed aspects of the exemplary embodiments can be made in addition to those described above by a person of ordinary skill in the art having the benefit of the present disclosure without departing from the spirit and scope of the disclosure contemplated by this disclosure and as defined in the following claims. As such, the scope of this disclosure is to be accorded the broadest reasonable interpretation so as to encompass such modifications and equivalent structures.

All references cited in the present disclosure are incorporated by reference in their entirety.

For the convenience of description, the components of the apparatus may be divided into various modules or units according to functions which may be separately described. Certainly, when various embodiments of the present disclosure are carried out, the functions of these modules or units can be achieved utilizing one or more equivalent units of hardware or software as will be recognized by those having skill in the art.

The various device components, units, blocks, or portions may have modular configurations, or are composed of discrete components, but nonetheless can be referred to as “modules” in general. In other words, the “components,” “modules” or “units” referred to herein may or may not be in modular forms.

Persons skilled in the art should understand that the embodiments of the present disclosure can be provided for a method, system, or computer program product. Thus, various embodiments of the present disclosure can be in form of all-hardware embodiments, all-software embodiments, or a mix of hardware-software embodiments. Moreover, various embodiments of the present disclosure can be in form of a computer program product implemented on one or more computer-applicable memory media (including, but not limited to, disk memory, CD-ROM, optical disk, etc.) containing computer-applicable procedure codes therein.

Various embodiments of the present disclosure are described with reference to the flow diagrams and/or block diagrams of the method, apparatus (system), and computer program product of the embodiments of the present disclosure. It should be understood that computer program instructions realize each flow and/or block in the flow diagrams and/or block diagrams as well as a combination of the flows and/or blocks in the flow diagrams and/or block diagrams. These computer program instructions can be provided to a processor of a general-purpose computer, a special-purpose computer, an embedded memory, or other programmable data processing apparatuses to generate a machine, such that the instructions executed by the processor of the computer or other programmable data processing apparatuses generate a device for performing functions specified in one or more flows of the flow diagrams and/or one or more blocks of the block diagrams.

These computer program instructions can also be stored in a computer-readable memory, such as a non-transitory computer-readable storage medium. The instructions can guide the computer or other programmable data processing apparatuses to operate in a specified manner, such that the instructions stored in the computer-readable memory generate an article of manufacture including an instruction device. The instruction device performs functions specified in one or more flows of the flow diagrams and/or one or more blocks of the block diagrams.

These computer program instructions may also be loaded on the computer or other programmable data processing apparatuses to execute a series of operations and steps on the computer or other programmable data processing apparatuses, such that the instructions executed on the computer or other programmable data processing apparatuses provide steps for performing functions specified ill one or more flows of the flow diagrams and/or one or more blocks of the block diagrams.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more modules of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium may be tangible.

For example, the motion-sickness methods and devices described above can be implemented as software applications (Apps), disseminated through various App stores, and users can download such Apps onto their mobile phones or tablet computers, and use such Apps while being passengers in an aircraft or vehicle, while following the visual or audio cues provided by the Apps on their displays to turn/rotate/control the device to turn left, right, up, down, etc., as if they are in control of the aircraft/vehicle as pilots/drivers themselves, thereby reducing motion sickness.

The operations described in this disclosure can be implemented as operations performed by a data processing apparatus on data stored on one or more computer-readable storage devices or received from other sources.

Processors suitable for the execution of a computer program such as the instructions described above include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

The processor or processing circuit can be implemented by one or a plurality of application specific integrated circuits (ASICs), digital signal processors (DSPs), digital signal processing devices (DSPDs), programmable logic devices (PLDs), field programmable gate arrays (FPGA), controllers, microcontrollers, microprocessors, general processors, or other electronic components, so as to perform the above image capturing method.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more portions of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

In some implementations, the model can reside on local processing circuits and storage devices, and the training of the model can also be performed locally. In some implementations, the model and the training can be remotely or distributed, such as in a cloud.

Data, such as the inputs, the outputs, and model predictions, can be presented to users/operators on display screens, such as organic light-emitting diode (OLED) displays screens and liquid-crystal display (LCD) screens located on a manufacturing line and/or in a control room.

Although preferred embodiments of the present disclosure have been described, persons skilled in the art can alter and modify these embodiments once they know the fundamental inventive concept. Therefore, the attached claims should be construed to include the preferred embodiments and all the alternations and modifications that fall into the extent of the present disclosure.

The description is only used to help understanding some of the possible methods and concepts. Meanwhile, those of ordinary skill in the art can change the specific implementation manners and the application scope according to the concepts of the present disclosure. The contents of this specification therefore should not be construed as limiting the disclosure.

In the foregoing method embodiments, for the sake of simplified descriptions, the various steps are expressed as a series of action combinations. However, those of ordinary skill in the art will understand that the present disclosure is not limited by the particular sequence of steps as described herein.

According to some other embodiments of the present disclosure, some steps can be performed in other orders, or simultaneously, omitted, or added to other sequences, as appropriate.

Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

| In addition, those of ordinary skill in the art will also understand that the embodiments described in the specification are just some of the embodiments, and the involved actions and portions are not all exclusively required, but will be recognized by those having skill in the art whether the functions of the various embodiments are required for a specific application thereof.

Various embodiments in this specification have been described in a progressive manner, where descriptions of some embodiments focus on the differences from other embodiments, and same or similar parts among the different embodiments are sometimes described together in only one embodiment.

It should also be noted that in the present disclosure, relational terms such as first and second, etc., are only used to distinguish one entity or operation from another entity or operation, and do not necessarily require or imply these entities having such an order or sequence. It does not necessarily require or imply that any such actual relationship or order exists between these entities or operations.

Moreover, the terms “include,” “including,” or any other variations thereof are intended to cover a non-exclusive inclusion such that a process, method, article, or apparatus that comprises a list of elements including not only those elements but also those that are not explicitly listed, or other elements that are inherent to such processes, methods, goods, or equipment.

In the case of no more limitation, the element defined by the sentence “includes a . . . ” does not exclude the existence of another identical element in the process, the method, the commodity, or the device including the element.

In the descriptions, with respect to device(s), terminal(s), etc., in some occurrences singular forms are used, and in some other occurrences plural forms are used in the descriptions of various embodiments. It should be noted, however, that the single or plural forms are not limiting but rather are for illustrative purposes. Unless it is expressly stated that a single device, or terminal, etc. is employed, or it is expressly stated that a plurality of devices, or terminals, etc. are employed, the device(s), terminal(s), etc. can be singular, or plural.

Based on various embodiments of the present disclosure, the disclosed apparatuses, devices, and methods can be implemented in other manners. For example, the abovementioned terminals devices are only of illustrative purposes, and other types of terminals and devices can employ the methods disclosed herein.

Dividing the terminal or device into different “portions,” “regions” “or “components” merely reflect various logical functions according to some embodiments, and actual implementations can have other divisions of “portions,” “regions,” or “components” realizing similar functions as described above, or without divisions. For example, multiple portions, regions, or components can be combined or can be integrated into another system. In addition, some features can be omitted, and some steps in the methods can be skipped.

Those of ordinary skill in the art will appreciate that the portions, or components, etc. in the devices provided by various embodiments described above can be configured in the one or more devices described above. They can also be located in one or multiple devices that is (are) different from the example embodiments described above or illustrated in the accompanying drawings. For example, the circuits, portions, or components, etc. in various embodiments described above can be integrated into one module or divided into several sub-modules.

The numbering of the various embodiments described above are only for the purpose of illustration, and do not represent preference of embodiments.

Although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the disclosure defined in the following claims, the scope of which is to be accorded the broadest interpretation to encompass such modifications and equivalent structures.

What is claimed is:

1. An electric vertical take-off and landing (eVTOL) aircraft comprising:
a fuselage;
a vertical propulsion system configured to enable vertical ascent and descent of eVTOL;
an auxiliary wing system comprising at least one deployable wing extendably stored during takeoff and landing, and extendable during horizontal flight to provide aerodynamic lift, thereby reducing reliance on the vertical propulsion system;
a wing deployment mechanism comprising automated actuators configured to deploy and retract the deployable wing; an onboard energy management system configured to distribute power among propulsion systems, avionics, and onboard battery storage; and
a renewable energy system integrated into the deployable wing, the renewable energy system comprising solar panels for capturing solar energy when the wing is extended.

2. The eVTOL aircraft of claim 1, further comprising a safety mechanism configured to transition the auxiliary wing system into an emergency descent mode, wherein the deployable wing doubles as a glide-assist or parachute device to enable emergency landings during critical flight failures.

3. The eVTOL aircraft of claim 1, wherein the auxiliary wing system further comprises control surfaces, including flaps and ailerons, configured to enhance stability and maneuverability during flight.

4. The eVTOL aircraft of claim 1, wherein the renewable energy system further comprises small wind turbines integrated into the wing structure, configured to convert airflow into supplemental electrical energy.

5. The eVTOL aircraft of claim 1, wherein the wing deployment mechanism is configured to dynamically adjust the geometry of the deployable wing during flight based on real-time flight parameters, including airspeed and altitude; and
wherein the flexible solar panels are fabricated from lightweight and durable materials to maintain aerodynamic efficiency while contributing additional power to the aircraft's propulsion and control systems.

6. The eVTOL aircraft of claim 1, wherein the wing deployment mechanism includes a pneumatic system configured to assist in the rapid deployment of the auxiliary wing; and
wherein the wing comprises at least one of advanced composites or polymers configured to optimize energy conversion and minimize weight.

7. The eVTOL aircraft of claim 1, further comprising smart sensors embedded within the auxiliary wing system to monitor structural health in real time.

8. The eVTOL aircraft of claim 1, wherein the renewable energy system dynamically is configured to adjust energy harvesting based on environmental factors, including sunlight intensity and wind speed.

9. The eVTOL aircraft of claim 1, further comprising a forced air system configured to inflate sections of the deployable wing to achieve optimal aerodynamic shape during flight.

10. The eVTOL aircraft of claim 1, wherein the auxiliary wing system further includes environmental sensors for data collection during flight, enabling applications in weather monitoring and environmental research.

11. The eVTOL aircraft of claim 1, wherein the onboard energy management system is configured to prioritize power delivery to essential systems during critical flight conditions.

12. The eVTOL aircraft of claim 2, wherein the emergency descent mode is configured to be activated by onboard sensors detecting a critical system failure or manually.

13. The eVTOL aircraft of claim 2, wherein the emergency descent mode includes a pre-programmed deployment sequence to stabilize the aircraft during a controlled glide and wherein emergency descent mode is activated by a ballistic device.

14. The eVTOL aircraft of claim 1, further comprising a system for reducing motion sickness, comprising:
a tactile feedback system integrated into wearable devices or environmental components to provide motion cues;
one or more sensors configured to detect motion and environmental changes, the sensors comprising at least one of accelerometers, gyroscopes, GPS receivers, cameras, radar, or LIDAR;
a computing device configured to process data from the one or more sensors and generate corresponding tactile feedback signals;
one or more tactile actuators embedded within the wearable devices or environmental components, the tactile actuators configured to apply pressure, vibration, or haptic feedback to simulate motion and assist in resolving sensory mismatches between the vestibular and proprioceptive systems; and
an artificial intelligence module configured to analyze motion patterns, predict vehicle movements, and generate preemptive tactile feedback cues.

15. The eVTOL aircraft of claim 14, wherein the wearable devices comprise at least one of:
a helmet or headband configured to provide non-visual, such as pressure-based cues simulating turns and directional changes;
a vest embedded with haptic actuators to simulate vertical motion, road texture, or acceleration changes configured to provide localized haptic feedback corresponding to movement.

16. The eVTOL aircraft of claim 14, wherein the environmental components comprise at least one of:
vehicle seats integrated with haptic actuators to provide pressure-based motion feedback;
an aircraft seat or cabin environment utilizing haptic feedback to assist passengers in anticipating motion changes.

17. The eVTOL aircraft of claim 14, wherein the computing device further comprises:
a motion detection module configured to process sensor data in real time;
a feedback control unit configured to dynamically adjust haptic signal intensity and duration based on detected vehicle movement; and
a wireless communication interface configured to synchronize vehicle movement with tactile feedback signals.

18. The eVTOL aircraft of claim 14, wherein the artificial intelligence module further comprises:
a predictive movement model configured to analyze past and real-time data to anticipate future vehicle motion;
a pre-planning guidance system configured to generate early alerts allowing users to anticipate movement changes; and
a user-adaptive learning system configured to adjust feedback based on individual user sensitivity and response patterns.

19. The eVTOL aircraft of claim 14, further comprising a non-transitory computer-readable medium storing instructions thereon for one or more processing circuit to execute to implement a method for mitigating motion sickness through feedback, comprising:
detecting at least one of:
motion using one or more motion sensors embedded in a wearable or environmental component; or
operator action;
processing sensor data using a computing device to determine motion intensity, direction, and expected changes;
generating feedback signals corresponding to at least one of the detected motion or the detected operator action;
delivering feedback through at least one of:
visual haptic or audio instructions for a user to perform simulated control actions corresponding to the detected operator action as if the user is the operator; or
one or more haptic actuators embedded in a wearable device or environmental component; and
synchronizing the feedback with predicted motion patterns to reduce sensory mismatches between the vestibular and proprioceptive systems.

20. The eVTOL aircraft of claim 19, wherein the tactile feedback is provided through at least one of:
localized pressure signals simulating forward, lateral, or rotational motion;
vibratory feedback simulating environmental changes such as turbulence, road texture, or acceleration forces; or dynamic intensity adjustments based on real-time motion and user response.
